(19) United States
(12) Patent Application Publication
(10) Pub. No.: US 2018/0081182 A1
(43) Pub. Date: Mar. 22, 2018

(54) ILLUMINATION DEVICE AND OBSERVATION SYSTEM

(71) Applicant: Sharp Kabushiki Kaisha, Sakai City, Osaka (JP)

(72) Inventors: Koji TAKAHASHI, Sakai City (JP); Hidenori KAWANISHI, Sakai City (JP)

(21) Appl. No.: 15/564,448

(22) PCT Filed: Mar. 15, 2016
(86) PCT No.: PCT/JP2016/058102

§ 371 Date: Oct. 5, 2017

(30) Foreign Application Priority Data
Apr. 15, 2015 (JP) 2015-083752

(51) Int. Cl. G02B 27/09; G02B 5/02; G02B 7/02; G02B 7/182; G03B 15/02; H04N 5/33; H04N 5/225

(52) U.S. Cl. CPC G02B 27/0916; G02B 5/021; G02B 7/02; G02B 6/0008; G03B 15/02; H04N 5/33; H04N 5/2256; G02B 7/182

(57) ABSTRACT

Near-infrared light is projected substantially uniformly. Included is an infrared semiconductor laser element (1) that emits a near-infrared laser beam (L1), a diffusion member (5) that does not include a fluorescent substance and that diffuses the near-infrared laser beam (L1), and a projection lens (6) that projects diffused light (L2) radiated from the diffusion member.

### TECHNICAL FIELD

The present invention relates to illumination devices and so on that project near-infrared light.

### BACKGROUND ART

To date, illumination devices are being developed that convert a laser beam emitted by a semiconductor laser element into fluorescent light or that scatter a laser beam to thus project fluorescent light or scattered light. An example of such an illumination device is disclosed in PTL 1 or 2.

PTL 1 discloses a projection device that includes a pumping light source (semiconductor laser element) that emits pumping light, a near-infrared light source that emits near-infrared light, a wavelength conversion member that converts the pumping light into light having a different wavelength, and a projection member the projects the light that has exited the wavelength conversion member. The wavelength conversion member includes a wavelength conversion layer that is formed by accumulated fluorescent particles that convert the wavelength of the pumping light into a different wavelength. Thus, the pumping light has its wavelength converted upon impinging on the wavelength conversion layer. Meanwhile, the near-infrared light is scattered by the wavelength conversion layer without having its wavelength being converted.

PTL 2 discloses a projection device that includes two or more semiconductor laser elements that emit laser beams that each has a wavelength in a visible range and that are of mutually different colors, and a light scattering member that scatters the laser beams without changing their wavelengths.

### CITATION LIST

### Patent Literature

PTL 1: Japanese Unexamined Patent Application Publication No. 2014-49369 (published on Mar. 17, 2014)

PTL 2: Japanese Unexamined Patent Application Publication No. 2011-65979 (published on Mar. 31, 2011)

### SUMMARY OF INVENTION

### Technical Problem

A high-power light source is required when near-infrared light is to be projected over a long distance. A semiconductor laser element can be selected for a high-power light source. In this case, however, since a laser beam emitted by a semiconductor laser element is highly coherent, moire-like non-uniformity may appear in a projected image. Although PTL 1 is directed to reducing the power consumption and to suppressing a misregistration between a visible light projection pattern and a near-infrared light projection pattern in the illumination device that can project visible light and near-infrared light, PTL 1 is silent as to constructing a configuration that can project the near-infrared light substantially uniformly. In addition, since PTL 2 does not provide a configuration that projects near-infrared light, as a matter of course, PTL 2 is silent as to constructing the above-described configuration.

The present invention has been made to solve the above problem and is directed to providing an illumination device that can project near-infrared light substantially uniformly.

### Solution to Problem

To solve the above problem, an illumination device according to an aspect of the present invention includes

a laser element that emits a near-infrared laser beam,

a diffusion member that does not include a fluorescent substance as a primary component and that diffuses the near-infrared laser beam, and

a projection member that projects a near-infrared laser beam diffused by the diffusion member.

### Advantageous Effects of Invention

According to an aspect of the present invention, an advantageous effect is provided in which a near-infrared laser beam can be projected substantially uniformly.

### BRIEF DESCRIPTION OF DRAWINGS

FIG. 1 is a schematic diagram illustrating a schematic configuration of an illumination device according to Embodiment 1 of the present invention.

FIG. 2 is a diagram illustrating a state in which a light receiving surface of a diffusion member provided in the illumination device is irradiated with a near-infrared laser beam.

FIG. 3 is a diagram illustrating how diffused light exits the diffusion member.

FIG. 4 is a diagram illustrating an example of a changing mechanism provided in the illumination device, in which (a) is a perspective view of the changing mechanism and (b) is a side view of the changing mechanism.

FIG. 5 is a diagram illustrating another example of a changing mechanism provided in the illumination device, in which (a) is a perspective view of the changing mechanism and (b) is a side view of the changing mechanism.

FIG. 6 is a schematic diagram illustrating a schematic configuration of an illumination device according to Embodiment 2 of the present invention.

FIG. 7 is a diagram illustrating a state in which a light receiving surface of a diffusion member provided in the illumination device is irradiated with a near-infrared laser beam.

FIG. 8 is a diagram illustrating how diffused light is radiated at the diffusion member.

FIG. 9 is a diagram illustrating yet another example of a changing mechanism provided in the illumination device, in which (a) is a perspective view of the changing mechanism and (b) is a sectional view of the changing mechanism.

FIG. 10(a) is a schematic diagram illustrating a schematic configuration of an illumination device according to Embodiment 3 of the present invention, and FIG. 10(b) is a diagram illustrating a shape of a radiation surface of a rod lens provided in the illumination device.

FIG. 11 is a diagram illustrating how diffused light is radiated at the rod lens.

FIG. 12 is a schematic diagram illustrating a schematic configuration of an illumination device according to Embodiment 4 of the present invention.

FIG. 13 is a diagram for describing an example of a changing mechanism provided in the illumination device, in which (a) is a diagram illustrating an example of a paraboloidal reflector provided in the illumination device and (b) is a diagram for describing the changing mechanism.

FIG. 14 is a schematic diagram illustrating a schematic configuration of an illumination device according to Embodiment 5 of the present invention.

FIG. 15 is a diagram illustrating a state in which a light receiving surface of a diffusion member provided in the illumination device is irradiated with a near-infrared laser beam.

FIG. 16 is a diagram illustrating how diffused light is radiated at the diffusion member.

FIG. 17 is a schematic diagram illustrating a schematic configuration of an illumination device according to Embodiment 6 of the present invention.

FIG. 18 is a perspective view illustrating a diffusion member provided in the illumination device.

FIG. 19 is a schematic diagram illustrating a schematic configuration of an observation system according to Embodiment 7 of the present invention.

### DESCRIPTION OF EMBODIMENTS

### Embodiment 1

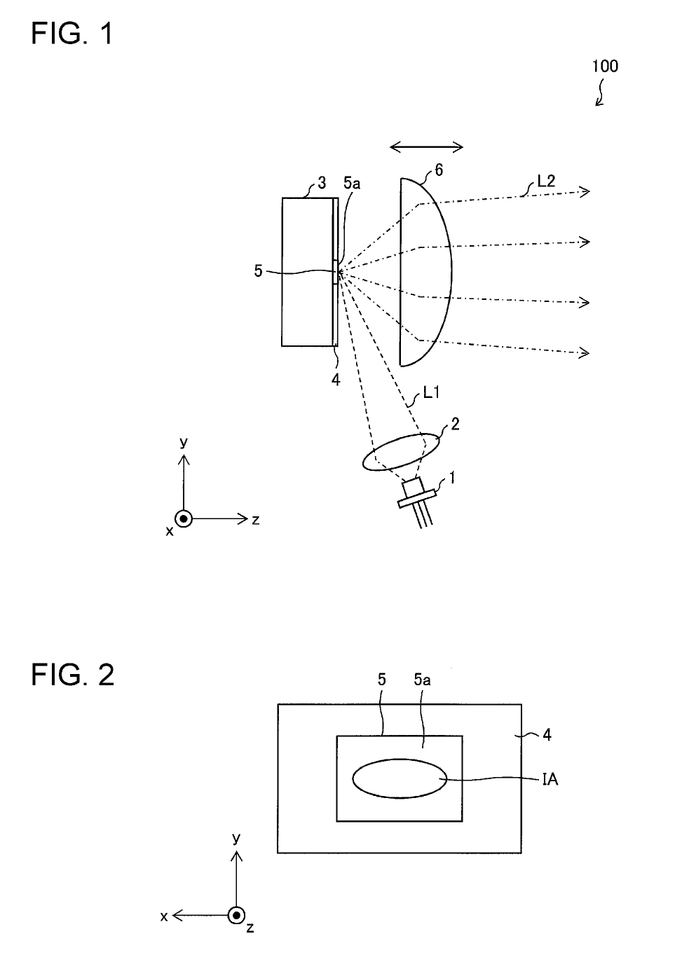

An embodiment of the present invention will be described as follows with reference to FIG. 1 to FIG. 5.

<Configuration of Illumination Device 100>

With reference to FIG. 1, an illumination device 100 according to the present embodiment will be described. FIG. 1 is a schematic diagram illustrating a schematic configuration of the illumination device 100 according to the present embodiment.

The illumination device 100 is a device that can project a near-infrared laser beam and functions as an infrared projector that, for example, irradiates a dark place. As illustrated in FIG. 1, the illumination device 100 primarily includes an infrared semiconductor laser element 1 (laser light source), a condenser lens 2, a support stand 3, a light absorbing member 4, a diffusion member 5, and a projection lens 6 (projection member, lens). The illumination device 100 diffuses (scatters) a near-infrared laser beam L1 emitted by the infrared semiconductor laser element 1 with the diffusion member 5 and projects the diffused near-infrared laser beam (diffused light L2) with the projection lens 6.

(Infrared Semiconductor Laser Element 1)

The infrared semiconductor laser element 1 emits only the near-infrared laser beam L1. The infrared semiconductor laser element 1 emits the near-infrared laser beam L1 having a peak wavelength of, for example, 810 nm at an output power of 20 W. The illumination device 100 according to the present embodiment includes one infrared semiconductor laser element 1. It suffices that the near-infrared laser beam L1 emitted by the infrared semiconductor laser element 1 have a peak wavelength in a wavelength band of no shorter than 740 nm nor longer than 1000 nm.

The infrared semiconductor laser element 1 is attached to a heat sink (not illustrated) for dissipating heat. With this configuration, heat produced in the infrared semiconductor laser element 1 is dissipated, and a deterioration of the infrared semiconductor laser element 1 can be suppressed. In addition, the infrared semiconductor laser element 1 is connected to a driving power supply circuit (not illustrated), and the emission of the near-infrared laser beam L1 from the infrared semiconductor laser element 1 is controlled by the stated power supply circuit.

In place of the infrared semiconductor laser element 1 according to the present embodiment, a laser generator such as a solid-state laser device or a gas laser device may be used. However, from the viewpoint of reducing the size of the illumination device 100, it is particularly preferable that a semiconductor laser element be used.

(Condenser Lens 2)

The condenser lens 2 is disposed between the infrared semiconductor laser element 1 and the diffusion member 5 and is a member that reduces the light spot of the near-infrared laser beam L1 emitted by the infrared semiconductor laser element 1 and condenses the near-infrared laser beam L1 onto the diffusion member 5. The condenser lens 2 is constituted, for example, by a convex lens made of glass or plastics.

(Support Stand 3)

The support stand 3 is a member that supports at least the diffusion member 5. The support stand 3 is formed, for example, of aluminum, but this is not a limiting example, and the support stand 3 may be formed of other metals, ceramics with high thermal conductivity, or the like. When such a material is used, heat produced as the diffusion member 5 (or the light absorbing member 4) is irradiated with the near-infrared laser beam L1 can be dissipated to the outside. In other words, in this case, the support stand 3 functions as a heat dissipating member (e.g., heat-dissipating fin).

(Light Absorbing Member 4)

The light absorbing member 4 is a member (light absorptive material) that absorbs the near-infrared laser beam L1 emitted by the near-infrared laser beam L1. The light absorbing member 4 is disposed on the support stand 3 so as to surround the periphery of the diffusion member 5 (refer to FIG. 2). The light absorbing member 4 is formed on the support stand 3 as carbon particles are applied on the support stand 3, for example. With this configuration, even in a case in which the diffusion member 5 is not irradiated appropriately with the near-infrared laser beam L1 emitted by the infrared semiconductor laser element 1, the near-infrared laser beam L1 can be absorbed by the light absorbing member 4. Therefore, the near-infrared laser beam L1 that has failed to be diffused by the diffusion member 5 can be prevented from being projected.

(Diffusion Member 5)

The diffusion member 5 includes a light diffusing element that does not include a fluorescent substance as a primary component, and is a plate-like member that diffuses with the light diffusing element the near-infrared laser beam L1 emitted by the infrared semiconductor laser element 1 and radiates the diffused near-infrared laser beam L1 as the diffused light L2. To rephrase, the diffusion member 5 is a member that does not include a fluorescent substance as a primary component.

Specifically, the emission spectrum of the near-infrared laser beam L1 incident on the diffusion member 5 is substantially identical to the emission spectrum of the near-infrared laser beam L1 diffused by the diffusion member 5 (diffused light L2). In these emission spectra, it is not necessary that all the spectral components be substantially identical, but it suffices that most of the spectral components be substantially identical. For example, it suffices that spectral components having an intensity that is no less than one-tenth the peak intensity of the emission spectra be substantially identical.

The diffusion member 5 includes a light receiving surface 5a that receives the near-infrared laser beam L1 emitted by the infrared semiconductor laser element 1, and fine concavities and convexities (rough surface) are formed in the light receiving surface 5a. With this configuration, the diffusion member 5 can efficiently diffuse the near-infrared laser beam L1 and can radiate the diffused light L2 in a state in which the spatial coherence of the near-infrared laser beam L1 is reduced.

In addition, it is preferable that the stated fine concavities and convexities be formed such that the arithmetic mean roughness of the light receiving surface 5a is no less than the peak wavelength of the near-infrared laser beam L1. A reason for this is that, in order to produce physical diffusion, the stated arithmetic mean roughness needs to be no less than the wavelength of the light (the wavelength range of the peak wavelength of the near-infrared laser beam L1). In consideration of the near-infrared laser beam L1 according to the present embodiment, it is preferable that the stated arithmetic mean roughness be no less than 1 μm.

In other words, in the present embodiment, the fine concavities and convexities formed in the light receiving surface 5a of the diffusion member 5 correspond to the light diffusing element.

In addition, the expression that the light diffusing element of the diffusion member 5 does not include a fluorescent substance as a primary component means that the proportion of a fluorescent substance with respect to the area of the light receiving surface 5a is no more than 10% in the present embodiment. The expression may also mean that it suffices that, of the components constituting the diffusion member 5, no less than 90% of the light diffusing element of the diffusion member 5 is constituted by a component other than a fluorescent substance. In other words, in the present embodiment, even when less than 10% of the components of the diffusion member 5 is a fluorescent substance, it may be considered that the light diffusing element of the diffusion member 5 does not include a fluorescent substance as a primary component.

In addition, it suffices that the light diffusing element that does not include a fluorescent substance as a primary component (the fine concavities and convexities described above) be formed at least only in an irradiation region of the near-infrared laser beam L1 formed on the light receiving surface 5a, and regions other than the stated irradiation region may include a fluorescent substance in a proportion no less than the proportion described above. In other words, it suffices that a fluorescent substance be scarcely present at least in the irradiation region of the near-infrared laser beam L1.

As illustrated in FIG. 2, the near-infrared laser beam L1 impinges on the vicinity of the center of the light receiving surface 5a of the diffusion member 5 and forms an irradiation region IA on the light receiving surface 5a. FIG. 2 is a diagram illustrating a state in which the light receiving surface 5a of the diffusion member 5 is irradiated with the near-infrared laser beam L1, as viewed from the +z-axis direction into the −z-axis direction. The near-infrared laser beam L1 emitted by the infrared semiconductor laser element 1 typically has an elliptical shape and impinges on the diffusion member 5 such that the length of the near-infrared laser beam L1 in the major axis direction is approximately 1 mm in the present embodiment. The size and the position of the irradiation region IA on the light receiving surface 5a can be adjusted by the relative positional relationship of the infrared semiconductor laser element 1, the condenser lens 2, and the diffusion member 5 and by the optical characteristics (refractive index and so on) of the condenser lens 2.

In addition, the diffusion member 5 diffuses the near-infrared laser beam L1 emitted by the infrared semiconductor laser element 1 at the light receiving surface 5a and radiates the diffused light L2 resulting from the diffusion of the near-infrared laser beam L1 toward the projection lens 6. With this configuration, the diffused light L2 can be radiated from the side of the light receiving surface 5a, or in other words, from the side on which the near-infrared laser beam L1 is incident. Then, the diffused light L2 radiated from the side of the light receiving surface 5a can be projected through the projection lens 6 disposed so as to oppose the light receiving surface 5a. Accordingly, a so-called reflection-type illumination device that radiates and projects light from a side of a scattering member on which the light is incident can be constructed as the illumination device 100.

The diffusion member 5 is formed, for example, of metal or the like, such as aluminum, but this is not a limiting example, and it is preferable that the diffusion member 5 be formed of a material having a high reflectance with respect to the wavelength of the near-infrared laser beam L1. In this case, the diffused light L2 can be directed efficiently toward the projection lens 6. In addition, as the stated reflectance of the material is higher, the utilization efficiency of the near-infrared laser beam L1 can be increased. Furthermore, it is preferable that the diffusion member 5 be formed of a nontransparent material having high thermal conductivity. In this case, heat produced through irradiation with the near-infrared laser beam L1 can be dissipated efficiently to the outside. It is not necessary that the entirety of the diffusion member 5 be formed of metal, and it suffices that at least the light receiving surface 5a be formed of metal.

The diffusion member 5 is not limited to aluminum having concavities and convexities in the surface thereof as illustrated, for example, in the present embodiment (i.e., a member that induces surface scattering), and a member that induces volume scattering can also be used. As a member that induces volume scattering, for example, a diffusion member or the like in which scattering substances (scattering particles, fillers, or the like) with different refractive indices are dispersed in a transparent member (glass or the like), for example, can be used. As such a member that induces surface scattering or volume scattering, aside from the diffusion member 5, there are a diffusion member 51 according to Embodiment 2 and a diffusion member 54 according to Embodiment 5.

(Projection Lens 6)

The projection lens 6 is a member that is disposed so as to oppose the light receiving surface 5a of the diffusion member 5, that transmits the diffused light L2, or the near-infrared laser beam diffused by the diffusion member 5, and that projects the diffused light L2 toward the outside of the illumination device 100 to image the diffused light L2. In other words, the projection lens 6 images the distribution (light distribution) of the diffused light L2 on the diffusion member 5 onto a location at a desired distance. The projection lens 6 is formed, for example, of glass or resin.

The projection lens 6 is a convex lens, and a plano-convex lens is used as the projection lens 6 in the present embodiment. This is not a limiting example, and a lens having a desired curved surface, such as a free-form surface, may be used as the projection lens 6.

In addition, the projection lens 6 is provided in the illumination device 100 such that the projection lens 6 can move toward the front side or the back side (in the directions indicated by the double-headed arrow in FIG. 1) of the illumination device 100. Specifically, the projection lens 6 can be moved in the ±z-directions by a changing mechanism (moving mechanism) that changes the relative position between the diffusion member 5 and the projection lens 6.

(How Diffused Light L2 is Radiated)

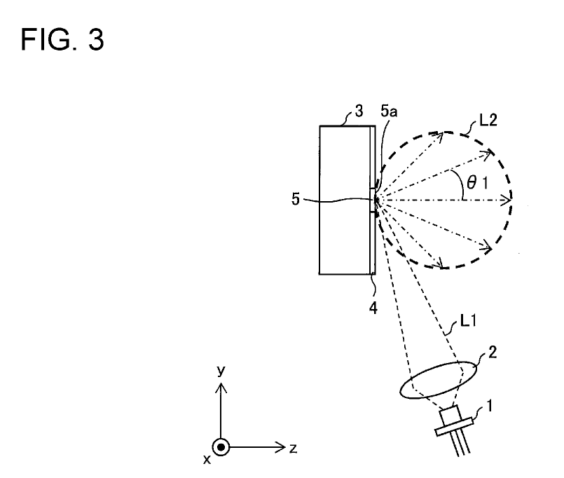

Next, with reference to FIG. 3, how the near-infrared laser beam L1 is diffused by the diffusion member 5 (i.e., how the diffused light L2 is radiated) as viewed from the +x-axis direction into the −x-axis direction will be described. FIG. 3 is a diagram illustrating how the diffused light L2 is radiated.

As illustrated in FIG. 3, the near-infrared laser beam L1 condensed on the light receiving surface 5a of the diffusion member 5 is diffused isotropically by the fine concavities and convexities provided in the light receiving surface 5a. At this point, the distribution of the diffused near-infrared laser beam L1 (diffused light L2) is the Lambertian distribution (Lambert distribution), which is an emission distribution in which the radiation distribution of the diffused light L2 can be approximated by cos θ1 when the angle of inclination from the line perpendicular to the light receiving surface 5a is represented by θ1. Specifically, the diffused light L2 is diffused with the highest intensity in the direction perpendicular to the light receiving surface 5a (+z-axis direction) and has an optical intensity that is cos θ1 times the highest intensity in the direction inclined by θ1 from the direction perpendicular to the light receiving surface 5a.

In the illumination device 100 according to the present embodiment, the light spot formed on the diffusion member 5 that is larger than the area of the emission point of the near-infrared laser beam L1 emitted by the infrared semiconductor laser element 1 is regarded as an apparent light source (virtual light source, two-dimensionally enlarged light source). Then, the diffused light L2 that is diffused in the Lambertian distribution as described above is radiated from this apparent light source, and the diffused light L2 is projected by the projection lens 6.

It is not necessary that the distribution of the diffused light L2 be the Lambertian distribution. In other words, it suffices that the diffused light L2 be radiated from the diffusion member 5 in a state in which the spatial coherence of the near-infrared laser beam L1 is reduced to such an extent that does not produce moire-like non-uniformity in the projected image (i.e., that does not cause a moire-like projected image).

(Changing Mechanism)

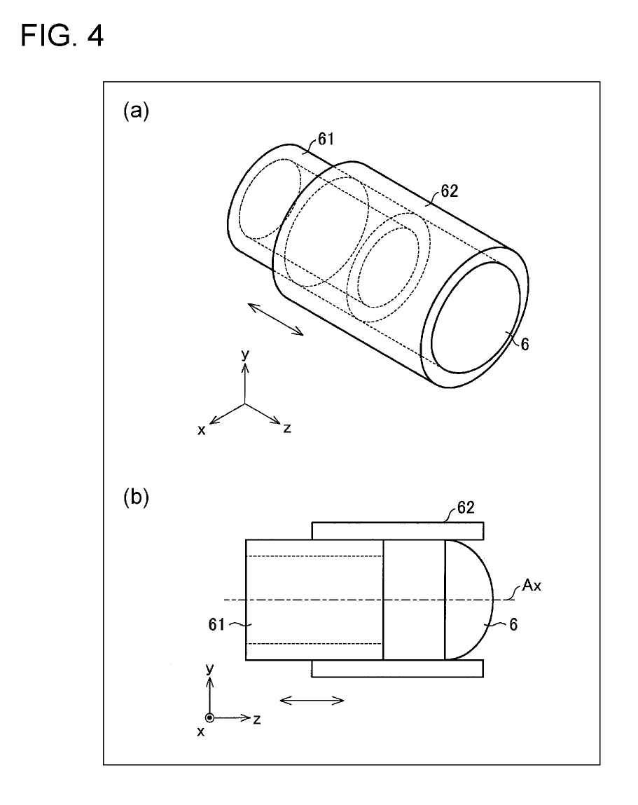

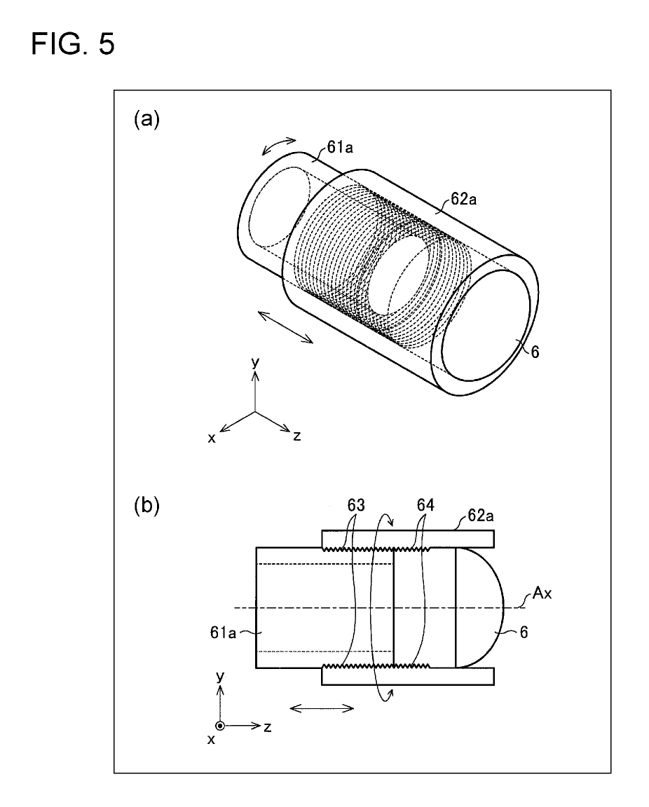

The illumination device 100 includes, aside from the members described above, a changing mechanism (moving mechanism) that can change the aforementioned relative position. Hereinafter, with reference to FIG. 4 and FIG. 5, the changing mechanism will be described. FIG. 4 and FIG. 5 are each a diagram illustrating an example of the changing mechanism.

(Fit-Type Changing Mechanism)

As illustrated in (a) and (b) of FIG. 4, the changing mechanism includes a lens housing 61 and a lens holder 62 and is of a fit type in which the lens holder 62 is fitted on the lens housing 61.

The lens housing 61 is attached to the housing of the illumination device 100 and is fixed to the stated housing. The lens housing 61 may instead be a portion of the housing of the illumination device 100. The lens housing 61 guides the diffused light L2 radiated from the light receiving surface 5a to the projection lens 6 and is hollow thereinside.

In addition, the lens housing 61 is disposed such that the center of a section perpendicular to an optical axis AX of the projection lens 6 lies on or is in the vicinity of the optical axis AX of the projection lens 6. Furthermore, the size of the section of the lens housing 61 (including a hollow portion) perpendicular to the optical axis AX of the projection lens 6 is substantially equal to the size of the section of the projection lens 6 that is perpendicular to the optical axis AX and that has the largest area.

The lens holder 62 is a member that supports thereinside the projection lens 6. Specifically, similarly to the lens housing 61, the lens holder 62 guides the diffused light L2 radiated from the light receiving surface 5a to the projection lens 6, is hollow thereinside, and supports the projection lens 6 at one end of the lens holder 62. In addition, similarly to the lens housing 61, the lens holder 62 is disposed such that the center of a section of the lens holder 62 perpendicular to the optical axis AX lies on or is in the vicinity of the optical axis AX of the projection lens 6 and is configured to allow the lens housing 61 to be fitted therein through the other end. In other words, the inner diameter of the lens holder 62 is substantially equal to the outer diameter of the lens housing 61 and the diameter of the aforementioned section of the projection lens 6, and the lens holder 62 is fitted on the lens housing 61 such that the outer wall of the lens housing 61 is in contact with the inner wall of the lens holder 62.

The lens holder 62 is fitted on the lens housing 61 and is configured to be capable of moving (sliding) relative to the lens housing 61 in the direction of the optical axis AX (the directions indicated by the double-headed arrow in FIG. 4). This movement may be controlled manually or electrically with an actuator or a motor (neither is illustrated), and a well-known technique can be employed.

(Screw-on Type Changing Mechanism)

As illustrated in (a) and (b) of FIG. 5, the changing mechanism includes a lens housing 61a and a lens holder 62a and is of a screw-on type in which the lens holder 62a is screwed on the lens housing 61a. The functions, the sizes, the shapes, and so on of the lens housing 61a and the lens holder 62a are similar to those of the lens housing 61 and the lens holder 62, respectively. However, the lens housing 61a and the lens holder 62a differ from the lens housing 61 and the lens holder 62, respectively, only in that the lens housing 61a includes a housing side screw portion 63 and the lens holder 62a includes a lens holder side screw portion 64.

The housing side screw portion 63 is formed at one end (the portion that is fitted in the lens holder 62a) of the outer wall of the lens housing 61a. The lens holder side screw portion 64 is formed at one end (the portion that is fitted on the lens housing 61a) of the inner wall of the lens holder 62a. With this configuration, the lens holder 62a is rotated and screwed onto the lens housing 61a, and thus the projection lens 6 can be moved in the ±z-axis directions (the directions indicated by the double-headed arrow in FIG. 5).

(Modification of Changing Mechanism)

It suffices that the lens housings 61 and 61a and the lens holders 62 and 62a be configured to be capable of moving the projection lens 6. For example, although FIG. 4 and FIG. 5 illustrate the lens housings 61 and 61a and the lens holders 62 and 62a that are cylindrical in shape, these are not limiting examples, and the lens holders 62 and 62a can have a desired shape such as a prism shape (each of the sections described above is rectangular). In addition, the inner diameters of the lens housings 61 and 61a may be greater than the outer diameters of the lens holders 62 and 62a, respectively. In other words, the configuration may be such that the inner walls of the lens housings 61 and 61a are in contact with the outer walls of the lens holders 62 and 62a, respectively.

The changing mechanisms illustrated in FIG. 4 and FIG. 5 can be applied to a configuration in which the position of the projection lens 6 is shifted. Specifically, the stated changing mechanisms can be applied to a projection lens 6 according to Embodiment 3, 5, or 6, which will be described later.

In addition, the inner walls of the lens housings 61 and 61a and the lens holders 62 and 62a may each be a mirror surface. In this case, the diffused light L2 radiated from the diffusion member 5 can be guided efficiently to the projection lens 6.

Furthermore, it suffices that the relative position between the diffusion member 5 and the projection lens 6 can be changed, and the configuration may be such that, instead of the projection lens 6 moving relative to the diffusion member 5, the diffusion member 5 moves relative to the projection lens 6 in the ±z-axis directions or both the projection lens 6 and the diffusion member 5 move.

(Advantageous Effect of Changing Mechanism)

The changing mechanism makes it possible to adjust the relative position between the diffusion member 5 and the projection lens 6. Thus, by adjusting the stated relative position, the diffused light L2 can, for example, be substantially collimated and then projected by the projection lens 6. In this case, the illumination device 100 can project the diffused light L2 over a long distance. In other words, the illumination device 100 can be used as a lamp for observing a dark place that can observe a target in a location at a long distance.

In order to project the diffused light L2 over a long distance, it is preferable that the stated relative position be defined such that the maximum angle of the angle (divergence angle) formed by an axis (z-axis) parallel to the optical axis of the projection lens 6 and the diffused light L2 radiated from the projection lens 6 is as small as possible (such that the diffused light L2 becomes substantially parallel light). As long as the stated relative position is defined in this manner, the relative position may be fixed. In this case, the changing mechanism does not need to be provided.

In addition, in order to project the diffused light L2 over a long distance by reducing the stated maximum angle (bringing the maximum angle to as close to zero as possible), in addition to adjusting the stated relative position with the changing mechanism, it is preferable that the radiation region (radiation point) of the diffused light L2 be small (i.e., point light source). In other words, it is preferable that the value (ratio) defined by “(the sectional area of the projection member)/(the radiation region of the diffused light L2)” be as large as possible.

<Modification>

In the foregoing description, the illumination device 100 includes a single infrared semiconductor laser element 1, but this is not a limiting example, and the illumination device 100 may include a plurality of infrared semiconductor laser elements 1. In this case, it is preferable that the infrared semiconductor laser elements 1 emit the near-infrared laser beams L1 toward the light receiving surface 5a such that the irradiation regions IA (refer to FIG. 2) of the respective near-infrared laser beams L1 overlap each other. With such emission control, the irradiation region IA, or in other words, the radiation region of the diffused light L2 can be made small even with the illumination device 100 that includes a plurality of infrared semiconductor laser elements 1. Therefore, the diffusion member 5 can be regarded as a point light source, and thus the diffused light L2 can be projected over a long distance.

<Primary Advantageous Effect of Illumination Device 100>

As an infrared semiconductor laser element is used to project a near-infrared laser beam, the near-infrared laser beam can be projected over a long distance. However, a near-infrared laser beam emitted by an infrared semiconductor laser element typically has high temporal and spatial coherences, and thus a moire-like projected image is produced when a target is irradiated with a near-infrared laser beam.

In addition, a near-infrared laser beam is not visible light and is typically used to irradiate a dark place, and thus it is difficult to observe a projected image with unaided eyes. In this case, a projected image is observed with an observation device such as an infrared camera, and thus a substantially uniform near-infrared laser beam with no moire needs to be projected in order to accurately grasp the state of the target, such as the shape or the pattern.

The illumination device 100 according to the present embodiment projects the diffused light L2 that has been diffused by the diffusion member 5, instead of directly projecting the near-infrared laser beam L1. With this configuration, the near-infrared laser beam L1 is diffused in random directions and radiated substantially uniformly. Therefore, the diffused light L2 can be projected in a state in which the spatial coherence is reduced, and an occurrence of a moire-like projected image can be suppressed.

In the illumination device 100, a projection optical system is constructed in which the irradiation region IA that is larger than the emission point of the infrared semiconductor laser element 1 serves as an apparent light source. Therefore, the size of the light source is substantially enlarged, and thus the near-infrared laser beam (diffused light L2) radiated from the diffusion member 5 is not condensed to a size greater than the size of the emission point even when an additional optical system, such as a lens, is provided. Thus, even when the near-infrared laser beam is seen through the light source (light receiving surface 5a) of which the apparent light source size is enlarged or through the aforementioned optical system, the near-infrared laser beam is not condensed on a retina over a certain extent. In other words, a highly safe illumination device can be provided.

In addition, when the intensity of the near-infrared laser beam (diffused light L2) is modulated in the illumination device 100, the illumination device 100 can carry out infrared communication using the near-infrared laser beam. In this case, the party that receives the near-infrared laser beam (infrared radiation) can suppress moire on a light receiving surface. Moire on a light receiving surface during infrared communication leads to noise with respect to a signal for communication, which can thus result in the deterioration of the communication quality. By carrying out the infrared communication with the illumination device 100, high-quality infrared communication with reduced noise can be achieved.

### Embodiment 2

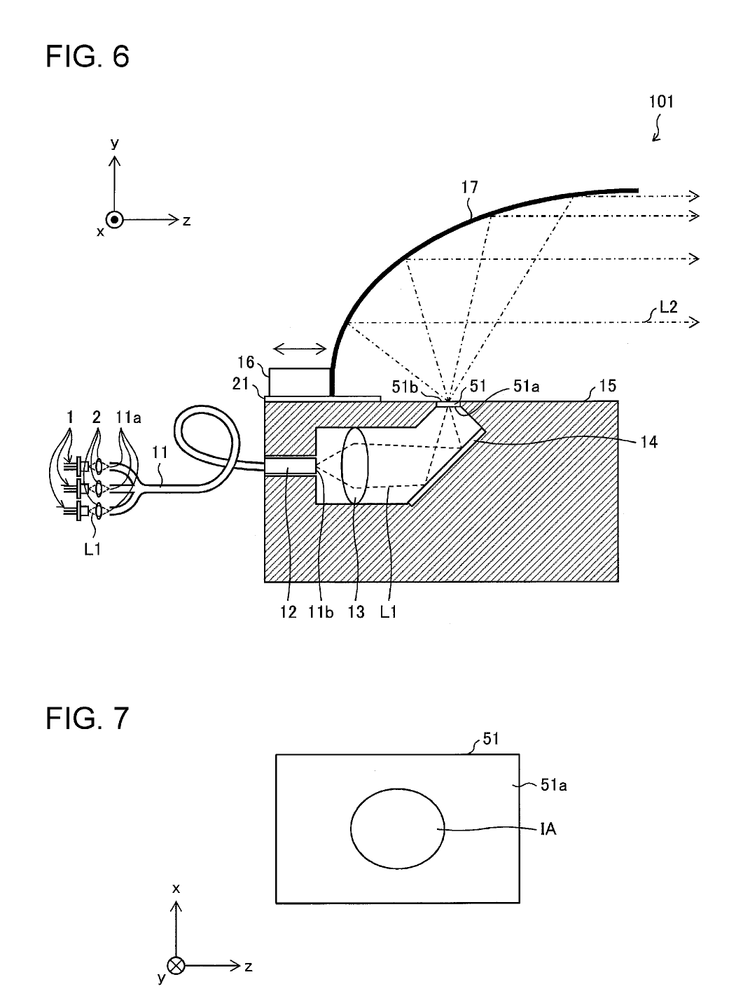

Another embodiment of the present invention will be described as follows with reference to FIG. 6 to FIG. 9. For simplifying the description, members having functions identical to those of the members described in the above embodiment are given identical reference characters, and descriptions thereof will be omitted.

<Configuration of Illumination Device 101>

With reference to FIG. 6, an illumination device 101 according to the present embodiment will be described. FIG. 6 is a schematic diagram illustrating a schematic configuration of the illumination device 101 according to the present embodiment.

The illumination device 101 is a device that can project a near-infrared laser beam and functions, for example, as an infrared projector that irradiates a dark place. As illustrated in FIG. 6, the illumination device 101 primarily includes infrared semiconductor laser elements 1, condenser lenses 2, an optical fiber 11, a ferrule 12, a condenser lens 13, a reflection mirror 14, a housing 15, a reflector support member 16, a paraboloidal reflector 17 (projection member, reflector), a guide portion 21, and a diffusion member 51. The illumination device 101 diffuses near-infrared laser beams L1 emitted by the infrared semiconductor laser elements 1 with the diffusion member 51 and projects a diffused near-infrared laser beam (diffused light L2) with the paraboloidal reflector 17.

(Infrared Semiconductor Laser Element 1)

The infrared semiconductor laser elements 1 according to the present embodiment emit the near-infrared laser beams L1 having a peak wavelength of, for example, 810 nm at an output power of 1 W. In addition, the illumination device 101 according to the present embodiment includes three infrared semiconductor laser elements 1, but the number of the infrared semiconductor laser elements 1 is not limited to three.

In addition, it is preferable that the near-infrared laser beams L1 impinge on a light receiving surface 51a such that irradiation regions IA (refer to FIG. 7) of the respective near-infrared laser beams L1 overlap each other. With this configuration, the irradiation region IA can be made small, and thus the radiation region of the diffused light L2 on a radiation surface 51b can be made small. Therefore, the diffusion member 51 can be regarded as a point light source, and thus the diffused light L2 can be projected over a long distance.

In the present embodiment, the plurality of near-infrared laser beams L1 input to the optical fiber 11 exit through a single radiation surface 11b of the optical fiber 11. Therefore, the plurality of near-infrared laser beams L1 radiated from the radiation surface 11b are superposed on each other and impinge on the light receiving surface 51a.

(Condenser Lens 2)

In the present embodiment, the condenser lens 2 is disposed between each of the infrared semiconductor laser elements 1 and a corresponding light receiving surface iia of the optical fiber 11. In other words, the illumination device 101 includes three condenser lenses 2.

(Optical Fiber 11)

The optical fiber 11 is a waveguide member that guides the near-infrared laser beams L1 emitted by the respective infrared semiconductor laser elements 1 to the vicinity of the condenser lens 13. The optical fiber 11 is, for example, a multimode optical fiber having a core with a circular section, but any type of optical fiber that can guide the near-infrared laser beams L1 to the vicinity of the condenser lens 13 may be used.

The optical fiber 11 includes the light receiving surfaces 11a that receive the near-infrared laser beams L1 and the radiation surface 11b through which the near-infrared laser beams L1 that have entered through the light receiving surfaces 11a are radiated. In the present embodiment, the optical fiber 11 includes three first optical fibers that include the respective light receiving surfaces 11a and one second optical fiber that includes the radiation surface 11b. Then, these three first optical fibers and the one second optical fiber are coupled by a combiner (not illustrated).

(Ferrule 12)

The ferrule 12 retains the radiation surface 11b of the optical fiber 11 in a predetermined pattern with respect to the condenser lens 13. The ferrule 12 may be one in which a hole into which the optical fiber 11 is inserted is formed in a predetermined pattern or one in which an upper portion and a lower portion can be separated and the optical fiber 11 is sandwiched by grooves formed in the respective bonding surfaces of the upper portion and the lower portion. The material of the ferrule 12 is not particularly limited and is, for example, stainless steel.

(Condenser Lens 13)

The condenser lens 13 is disposed between the radiation surface 11b of the optical fiber 11 and the reflection mirror 14 and is a member the reduces the light spot of the near-infrared laser beams L1 radiated from the radiation surface 11b and condenses the near-infrared laser beams L1 onto the reflection mirror 14. The condenser lens 13 is constituted, for example, by a convex lens made of glass.

(Reflection Mirror 14)

The reflection mirror 14 reflects the near-infrared laser beams L1 transmitted through the condenser lens 13 and irradiates the diffusion member 51 with the near-infrared laser beams L1. The inner wall of the reflection mirror 14 may be coated with metal, such as aluminum, or the reflection mirror 14 may be a member made of metal or may be a dielectric multilayer coating mirror.

(Housing 15)

The housing 15 is a member that houses the ferrule 12 (optical fiber 11), the condenser lens 13, the reflection mirror 14, and the diffusion member 51. Specifically, formed inside the housing 15 is a path that guides the near-infrared laser beams L1 radiated from the optical fiber 11 to the diffusion member 51 and that allows the diffused light L2 to be radiated from the diffusion member 51 toward the paraboloidal reflector 17. The members described above are fixed in that path.

The housing 15 is formed, for example, of aluminum, but this is not a limiting example, and the housing 15 may be formed of other metals, ceramics with high thermal conductivity, or the like. When such a material is used, heat produced by the near-infrared laser beams L1 in each of the members described above can be dissipated to the outside. In other words, in this case, the housing 15 functions as a heat dissipating member.

(Reflector Support Member 16)

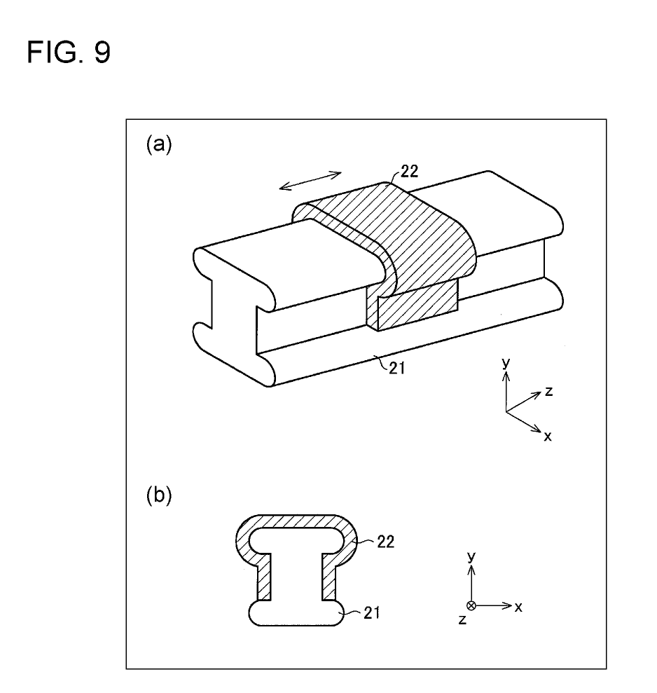

The reflector support member 16 is a member that supports the paraboloidal reflector 17. In addition, a slide portion 22 fitted on the guide portion 21 (refer to FIG. 9) is fixed on the reflector support member 16. With this configuration, the paraboloidal reflector 17 can be moved in the ±z-axis directions. The reflector support member 16 may serve as the slide portion 22.

(Paraboloidal Reflector 17)

The paraboloidal reflector 17 is a concave mirror that is disposed so as to oppose the radiation surface 51b of the diffusion member 51, that reflects the diffused light L2 radiated from the diffusion member 51, and that forms a pencil of rays (illumination light) that travels within a predetermined solid angle. In addition, the paraboloidal reflector 17 is a member that projects the diffused light L2 serving as the illumination light toward the outside of the illumination device 101. In other words, the paraboloidal reflector 17 images the distribution (light distribution) of the diffused light L2 on the diffusion member 51 onto a location at a desired distance. The paraboloidal reflector 17 may, for example, be a member made of resin on the surface of which a metal thin film is formed or may be a member made of metal.

The reflective surface of the paraboloidal reflector 17 includes at least a portion of a partial curved surface obtained by cutting a curved surface (paraboloid of revolution) formed by rotating a parabola about an axis of symmetry of the parabola, serving as the axis of rotation, along a plane that includes the stated axis of rotation. When the paraboloidal reflector 17 is viewed from the front of the illumination device 101, the aperture portion of the paraboloidal reflector 17 (the outlet of the illumination light) is semicircular.

In place of the paraboloidal reflector 17, a reflector having a desired curved surface, such as free-form surface, may be used as long as such a reflector is configured to be capable of projecting the diffused light L2 toward the front of the illumination device 101. However, in order to project the diffused light L2 over a long distance, it is preferable that a paraboloidal reflector (a reflector of which the reflective surface includes at least a portion of a paraboloid of revolution) be used as a projection member.

In addition, the paraboloidal reflector 17 is provided in the illumination device 101 such that the paraboloidal reflector 17 can move toward the front side or the back side (in the directions indicated by the double-headed arrow in FIG. 6) of the illumination device 101. Specifically, the paraboloidal reflector 17 can be moved in the ±z-axis directions by a changing mechanism (moving mechanism) that changes the relative position between the diffusion member 51 and the paraboloidal reflector 17.

(Guide Portion 21)

The guide portion 21 is disposed on the surface of the housing 15 and is a member that enables the slide portion 22 fitted thereon (refer to FIG. 9) to move in the ±z-axis directions.

(Diffusion Member 51)

The diffusion member 51 is a plate-like member that includes a light diffusing element that does not include a fluorescent substance as a primary component, that diffuses the near-infrared laser beams L1 emitted by the infrared semiconductor laser elements 1 with the light diffusing element, and that radiates the diffused near-infrared laser beams L1 as the diffused light L2. To rephrase, the diffusion member 51 is a member that does not include a fluorescent substance as a primary component.

Specifically, the emission spectrum of the near-infrared laser beams L1 incident on the diffusion member 51 is substantially identical to the emission spectrum of the diffused light L2. Similarly to Embodiment 1, in these emission spectra, it is not necessary that all the spectral components be substantially identical.

The diffusion member 51 includes the light receiving surface 51a that receives the near-infrared laser beams L1 emitted by the infrared semiconductor laser elements 1 and the radiation surface 51b that is opposite to the light receiving surface 51a and that radiates the diffused light L2 toward the paraboloidal reflector 17. In other words, the diffusion member 51 is a transparent member that can transmit the near-infrared laser beams L1 or the diffused light L2.

Fine concavities and convexities are formed at least in one of the light receiving surface 51a and the radiation surface 51b. In other words, the diffusion member 51 is a so-called frosted glass of which the surface is roughened. With this configuration, the diffusion member 51 can efficiently diffuse the near-infrared laser beams L1 and can radiate the diffused light L2 in a state in which the spatial coherence of the near-infrared laser beams L1 is reduced. The arithmetic mean roughness of the light receiving surface 51a and/or the radiation surface 51b in which the fine concavities and convexities are formed is similar to that of the light receiving surface 5a according to Embodiment 1.

In other words, in the present embodiment, the fine concavities and convexities formed in the light receiving surface 51a or the radiation surface 51b of the diffusion member 51 correspond to the light diffusing element.

In addition, the expression that the light diffusing element of the diffusion member 51 does not include a fluorescent substance as a primary component means that the proportion of the fluorescent substance with respect to the area of the light receiving surface 51a or the radiation surface 51b in which the fine concavities and convexities are formed is no more than 10% in the present embodiment. The expression may also mean that it suffices that, of the components constituting the diffusion member 51, no less than 90% of the light diffusing element of the diffusion member 51 is constituted by a component other than a fluorescent substance.

In addition, it suffices that the light diffusing element that does not include a fluorescent substance as a primary component (the fine concavities and convexities described above) be formed at least only in the irradiation region of the near-infrared laser beams L1 formed on the light receiving surface 51a or only in the irradiation region of the near-infrared laser beams L1 formed on the radiation surface 51b (i.e., the region from which the diffused light L2 is radiated). In other words, it suffices that a fluorescent substance is scarcely present at least in the irradiation region of the near-infrared laser beams L1, and regions other than the irradiation region may include a fluorescent substance in a proportion no less than the proportion described above.

In addition, according to the configuration described above, the diffusion member 51 can radiate the diffused light L2 from the side of the radiation surface 51b that is opposite to the light receiving surface 51a. Then, the diffused light L2 radiated from the side of the radiation surface 51b can be projected by the paraboloidal reflector 17. Accordingly, a so-called transmission-type illumination device that radiates and projects light from a side of the scattering member that is opposite to the side on which the light is incident can be constructed as the illumination device 101.

As illustrated in FIG. 7, the near-infrared laser beams L1 impinge on the vicinity of the center of the light receiving surface 51a of the diffusion member 51 and form the irradiation region IA on the light receiving surface 51a. FIG. 7 is a diagram illustrating a state in which the light receiving surface 51a of the diffusion member 51 is irradiated with the near-infrared laser beams L1, as viewed from the −y-axis direction into the +y-axis direction. The near-infrared laser beams L1 propagate inside of the optical fiber 11 and thus form a substantially circular irradiation region IA. In the present embodiment, the diffusion member 51 is irradiated such that the diameter of the irradiation region IA is 1.2 mm. The size and the position of the irradiation region IA on the light receiving surface 51a can be adjusted by the relative positional relationship of the radiation surface 11b of the optical fiber 11, the condenser lens 13, the reflection mirror 14, and the diffusion member 51 and by the optical characteristics (refractive index, reflectance, and so on) of the condenser lens 13 and the reflection mirror 14.

It suffices that the diffusion member 51 be formed of a material that can transmit the near-infrared laser beams L1 or the diffused light L2, and examples of such a material include glass, quartz, and sapphire.

(How Diffused Light L2 is Radiated)

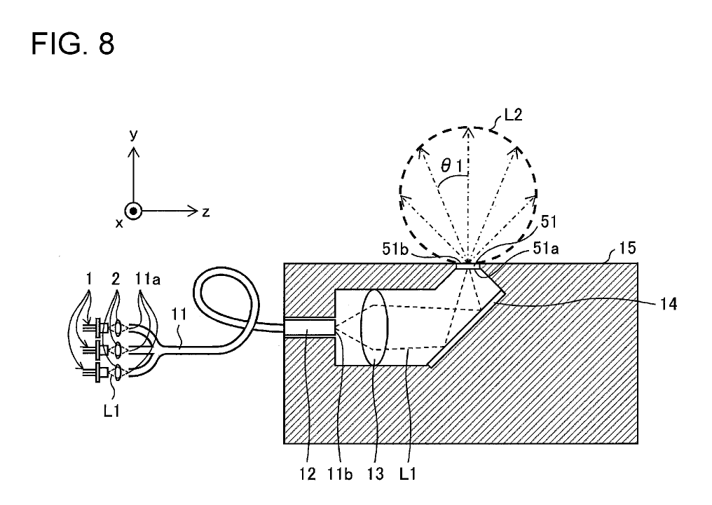

Next, with reference to FIG. 8, how the near-infrared laser beams L1 are diffused by the diffusion member 51 (i.e., how the diffused light L2 is radiated) as viewed from the +x-axis direction into the −x-axis direction will be described. FIG. 8 is a diagram illustrating how the diffused light L2 is radiated.

As illustrated in FIG. 8, the near-infrared laser beams L1 condensed on the light receiving surface 51a of the diffusion member 51 are diffused isotropically by the fine concavities and convexities provided in the light receiving surface 51a and/or the radiation surface 51b. At this point, similarly to Embodiment 1, the distribution of the diffused light L2 is the Lambertian distribution.

In the illumination device 101 according to the present embodiment as well, the light spot formed on the diffusion member 51 that is larger than the area of the emission point of the near-infrared laser beams L1 emitted by the infrared semiconductor laser elements 1 is regarded as an apparent light source. Then, the diffused light L2 that is diffused in the Lambertian distribution as described above is radiated from this apparent light source, and the diffused light L2 is projected by the paraboloidal reflector 17.

(Changing Mechanism)

The illumination device 101 includes, aside from the members described above, a changing mechanism (moving mechanism) that can change the relative position described above. Hereinafter, with reference to FIG. 9, the changing mechanism will be described. FIG. 9 is a diagram illustrating an example of the changing mechanism.

As illustrated in (a) and (b) of FIG. 9, the changing mechanism includes the guide portion 21 and the slide portion 22 and is of a slider type in which the slide portion 22 slides on the guide portion 21.

As described above, the guide portion 21 is a rail-like member that enables the slide portion 22 fitted thereon to move in the ±z-axis directions. Thus, the guide portion 21 is integrated with the housing 15 as being disposed on the surface of the housing 15 so as to extend in the +z-axis direction (the direction in which the diffused light L2 is projected). The guide portion 21 may be a portion of the housing 15.

The slide portion 22 is fitted on the guide portion 21 and can move in the direction in which the guide portion 21 extends (the directions indicated by the double-headed arrow in FIG. 9) as being slid on the guide portion 21. This movement may be controlled manually or electrically with an actuator or a motor (neither is illustrated), and a well-known technique can be employed. In addition, the slide portion 22 is fixed on the reflector support member 16. Thus, the reflector support member 16 and the paraboloidal reflector 17 can move along with the movement of the slide portion 22.

The changing mechanism illustrated in FIG. 9 can be applied to a configuration in which the position of the paraboloidal reflector 17 is shifted. Specifically, the stated changing mechanism can be applied to a paraboloidal reflector 17 according to Embodiment 6, which will be described later.

Furthermore, it suffices that the relative position between the diffusion member 51 and the paraboloidal reflector 17 can be changed, and the configuration may be such that, instead of the paraboloidal reflector 17 moving relative to the diffusion member 51, the diffusion member 51 moves relative to the paraboloidal reflector 17 in the ±z-axis directions or both the paraboloidal reflector 17 and the diffusion member 5 move.

(Advantageous Effect of Changing Mechanism)

Similarly to Embodiment 1, the changing mechanism makes it possible to adjust the relative position between the diffusion member 51 and the paraboloidal reflector 17. Therefore, by adjusting the stated relative position, the diffused light L2 can, for example, be substantially collimated and then projected by the paraboloidal reflector 17. In this case, the illumination device 101 can project the diffused light L2 over a long distance. In other words, the illumination device 101 can be used as a lamp for observing a dark place that can observe a target in a location at a long distance.

In order to project the diffused light L2 over a long distance, it is preferable that the stated relative position be defined such that the maximum angle of the angle (divergence angle) formed by the line perpendicular (z-axis) to the aperture surface of the paraboloidal reflector 17 and the diffused light L2 radiated from the paraboloidal reflector 17 is small. As long as the stated relative position is defined in this manner, the relative position may be fixed. In this case, the changing mechanism does not need to be provided.

<Primary Advantageous Effect of Illumination Device 101>

Similarly to Embodiment 1, the illumination device 101 diffuses the near-infrared laser beams L1 with the diffusion member 51 and projects the diffused light L2 of which the spatial coherence is reduced. Therefore, the diffused light L2 can be projected in a state in which the spatial coherence is reduced, and an occurrence of a moire-like projected image can be suppressed. In addition, a highly safe illumination device can be provided.

### Embodiment 3

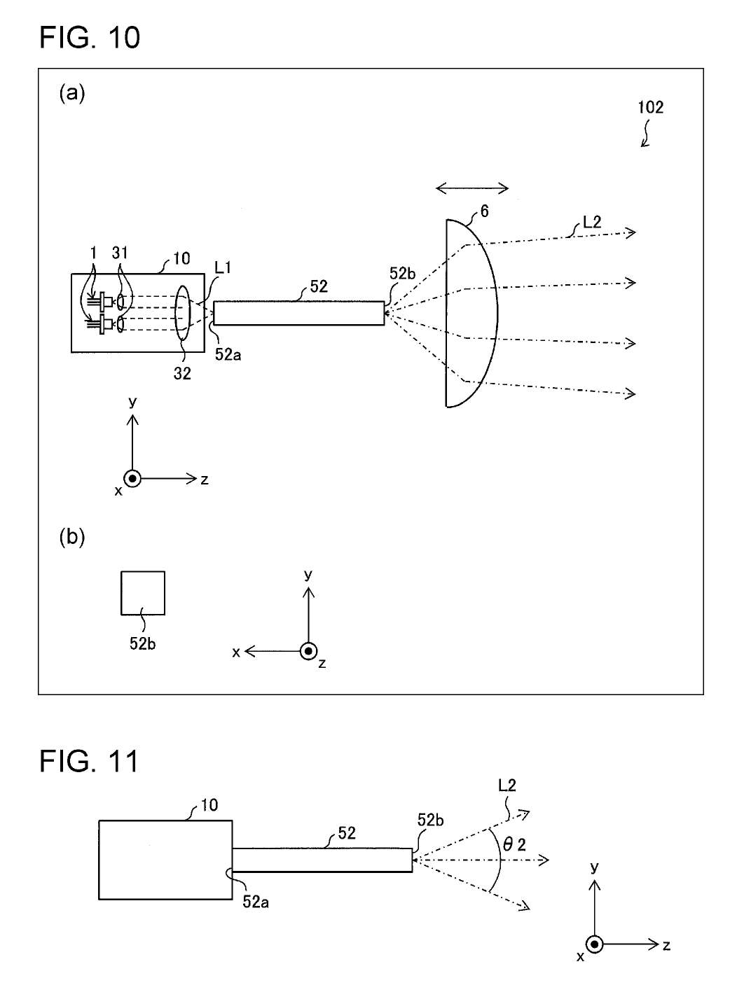

Another embodiment of the present invention will be described as follows with reference to FIG. 10 and FIG. 11. For simplifying the description, members having functions identical to those of the members described in the above embodiments are given identical reference characters, and descriptions thereof will be omitted.

<Configuration of Illumination Device 102>

With reference to FIG. 10, an illumination device 102 according to the present embodiment will be described. The section (a) of FIG. 10 is a schematic diagram illustrating a schematic configuration of the illumination device 102 according to the present embodiment, and the section (b) of FIG. 10 is a diagram illustrating a shape of a radiation surface 52b of a rod lens 52 (diffusion member). The double-headed arrow illustrated in (a) of FIG. 10 indicates the directions in which a projection lens 6 can move.

The illumination device 102 is a device that can project a near-infrared laser beam and functions, for example, as an infrared projector that irradiates a dark place. As illustrated in (a) of FIG. 10, the illumination device 102 primarily includes a laser light source unit 10, the rod lens 52, and the projection lens 6. The illumination device 102 guides near-infrared laser beams L1 emitted by respective infrared semiconductor laser elements 1 provided in the laser light source unit 10 through the inside of the rod lens 52, diffuses the guided near-infrared laser beams L1, and projects diffused light L2 with the projection lens 6.

(Laser Light Source Unit 10)

The laser light source unit 10 is a member that causes the near-infrared laser beams L1 to be incident on the rod lens 52 and primarily includes the infrared semiconductor laser elements 1, condenser lenses 31, and a condenser lens 32.

(Infrared Semiconductor Laser Element 1)

The illumination device 102 according to the present embodiment includes two infrared semiconductor laser elements 1. One of the infrared semiconductor laser elements 1 emits a near-infrared laser beam L1 having a peak wavelength of, for example, 790 nm at an output power of 1 W. The other one of the infrared semiconductor laser elements 1 emits a near-infrared laser beam L1 having a peak wavelength of, for example, 810 nm at an output power of 1 W. In other words, the two infrared semiconductor laser elements 1 emit the near-infrared laser beams L1 having mutually different peak wavelengths. Although the illumination device 102 according to the present embodiment includes two infrared semiconductor laser elements 1, the number of the infrared semiconductor laser elements 1 is not limited to two.

(Condenser Lens 31 and Condenser Lens 32)

The condenser lens 31 is disposed between each of the infrared semiconductor laser elements 1 and the condenser lens 32 and is a member that substantially collimates the near-infrared laser beams L1 emitted by the respective infrared semiconductor laser elements 1 and radiates the near-infrared laser beams L1 toward the condenser lens 32. In other words, the illumination device 102 includes two condenser lenses 31.

The condenser lens 32 is disposed between the condenser lenses 31 and a light receiving surface 52a of the rod lens 52 and is a member that condenses the near-infrared laser beams L1 radiated from the respective condenser lenses 31 onto the light receiving surface 52a of the rod lens 52.

The condenser lenses 31 and 32 are constituted, for example, by convex lenses made of glass.

(Rod Lens 52)

The rod lens 52 is a member that does not include a fluorescent substance as a primary component and that diffuses the near-infrared laser beams L1 emitted by the infrared semiconductor laser elements 1 to radiate the diffused light L2.

In other words, the emission spectrum of the near-infrared laser beams L1 incident on the rod lens 52 is substantially identical to the emission spectrum of the diffused light L2. Similarly to Embodiment 1, in these emission spectra, it is not necessary that all the spectral components be substantially identical.

In addition, the rod lens 52 includes the light receiving surface 52a that receives the near-infrared laser beams L1 emitted by the infrared semiconductor laser elements 1 and the radiation surface 52b that is opposite to the light receiving surface 52a and that radiates the diffused light L2 toward the projection lens 6. The two near-infrared laser beams L1 having different peak wavelengths emitted by the respective infrared semiconductor laser elements 1 are mixed inside the rod lens 52 and radiated from the radiation surface 52b.

In addition, the rod lens 52 is a waveguide member that guides the near-infrared laser beams L1 while reflecting the near-infrared laser beams L1 a plurality of times thereinside. Specifically, the rod lens 52 is formed, for example, of glass. In other words, the inside of the rod lens 52 is filled with glass. Therefore, the near-infrared laser beams L1 propagate inside of the rod lens 52 while undergoing total reflection a plurality times at the inner wall of the rod lens 52 due to the difference between the refractive index of glass (inside the rod lens 52) and the refractive index of the air (outside the rod lens 52). Thus, the near-infrared laser beams L1 go out of phase propagating inside of the rod lens 52. Therefore, the rod lens 52 can radiate the diffused light L2 in a state in which the temporal coherence of the near-infrared laser beams L1 is reduced.

In addition, the rod lens 52 does not include a fluorescent substance as a primary component. This means, for example, that no less than 90% of the components constituting the rod lens 52 is constituted by a component other than a fluorescent substance.

In addition, as illustrated in (b) of FIG. 10, in the present embodiment, the shape of the radiation surface 52b is rectangular. In other words, the shape of the section of the rod lens 52 perpendicular to the optical axis thereof is rectangular. In addition, the area of the radiation surface 52b is sufficiently larger than the area of the emission point of the infrared semiconductor laser elements 1. In addition, the area of the radiation surface 52b is larger than the irradiation region IA formed on the diffusion members 5 and 51 according to Embodiments 1 and 2, respectively. Therefore, the rod lens 52 can radiate the diffused light L2 in a state in which the temporal coherence is further reduced.

In other words, the illumination device 102 can radiate, from the radiation surface 52b, the diffused light L2 obtained by diffusing the near-infrared laser beams L1 by allowing the near-infrared laser beams L1 to pass through the inside of the rod lens 52.

In addition, according to the configuration described above, the rod lens 52 can guide the diffused light L2 from the light receiving surface 52a to the radiation surface 52b and radiate the diffused light L2 from the side of the radiation surface 52b. Then, the diffused light L2 radiated from the side of the radiation surface 52b can be projected by the projection lens 6. Accordingly, a so-called a waveguide-type (light guide-type) illumination device that projects light guided from a side of the scattering member on which the light is incident to a side from which the light is radiated can be constructed as the illumination device 102.

It suffices that the rod lens 52 be formed of a material that can transmit the near-infrared laser beams L1, and examples of such a material include, aside from glass, sapphire, crystal, and resin such as plastics. In addition, it is not necessary that the sectional shape of the rod lens 52 be rectangular, and the sectional shape may be any desired shape, such as a circle. In other words, it suffices that the rod lens 52 be made of a material and have a shape that can guide the near-infrared laser beams L1.

Furthermore, in place of the rod lens 52, a waveguide member that is hollow thereinside can be used. Examples of such a waveguide member include (1) a waveguide member having an inner wall formed of a thin transparent material and (2) a kaleidoscope-like waveguide member having an inner wall formed of a material with a reflective property.

(How Diffused Light L2 is Radiated)

Next, with reference to FIG. 11, how the near-infrared laser beams L1 are diffused by the rod lens 52 (i.e., how the diffused light L2 is radiated) as viewed from the +x-axis direction into the −x-axis direction will be described. FIG. 11 is a diagram illustrating how the diffused light L2 is radiated.

As illustrated in FIG. 11, the near-infrared laser beams L1 incident on the light receiving surface 52a of the rod lens 52 are guided through the rod lens 52, and the diffused light L2 is diffused from the radiation surface 52b. At this point, the total angle θ2 of radiation of the diffused light L2 radiated from the radiation surface 52b is 60°. In other words, the shape, the material, and the optical characteristics (refractive index and so on) of the rod lens 52 are defined such that the total angle θ2 of radiation becomes 60°. The total angle θ2 of radiation is an angle formed by the diffused light L2 having an intensity that is one-half the intensity on an axis that passes through the center of the radiation surface 52b (the optical axis of the rod lens 52) across the stated axis along the plane including the axis.

It is not necessary that the total angle θ2 of radiation be 60°. It suffices that the total angle θ2 of radiation be controlled, for example, in consideration of the optical characteristics (refractive index and so on) of the projection lens 6.

In the illumination device 102 according to the present embodiment, the radiation surface 52b on which the light spot is larger than the area of the emission point of the near-infrared laser beams L1 emitted by the infrared semiconductor laser elements 1 is regarded as an apparent light source. Then, the diffused light L2 that is diffused as described above is radiated from this apparent light source, and the diffused light L2 is projected by the projection lens 6.

(Changing Mechanism)

In addition, the illumination device 102 includes, aside from the members described above, a changing mechanism that changes the relative position between the rod lens 52 and the projection lens 6. With this configuration, similarly to Embodiment 1, the relative position between the rod lens 52 and the projection lens 6 can be adjusted, and the diffused light L2 can be projected over a long distance. Aside from the above, the configuration and the advantageous effect of the changing mechanism have been described in Embodiment 1, and thus descriptions thereof will be omitted in the present embodiment.

<Primary Advantageous Effect of Illumination Device 102>

Similarly to Embodiments 1 and 2, the illumination device 102 diffuses the near-infrared laser beams L1 with the rod lens 52 and projects the diffused light L2. Therefore, the diffused light L2 can be projected in a state in which the temporal and spatial coherences are reduced, and an occurrence of a moire-like projected image can be suppressed. In addition, a highly safe illumination device can be provided.

### Embodiment 4

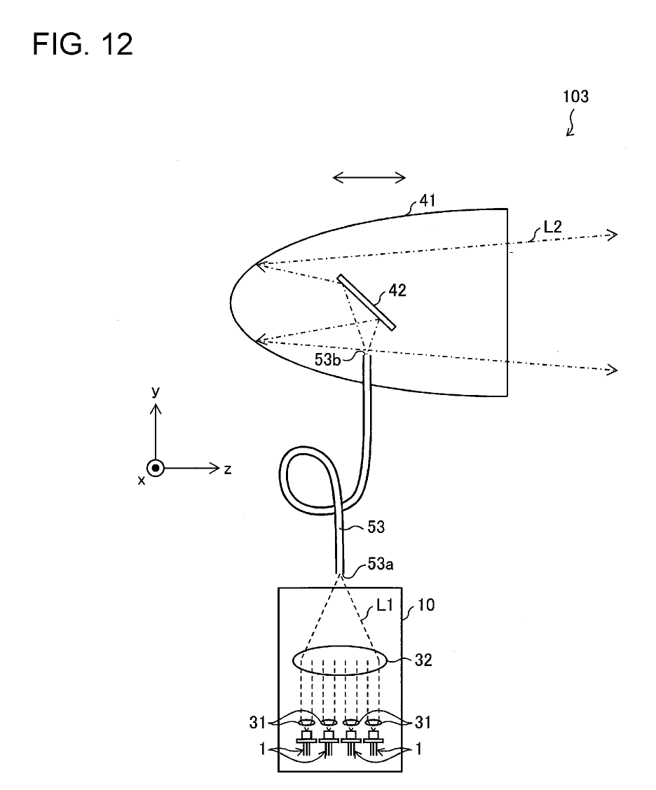

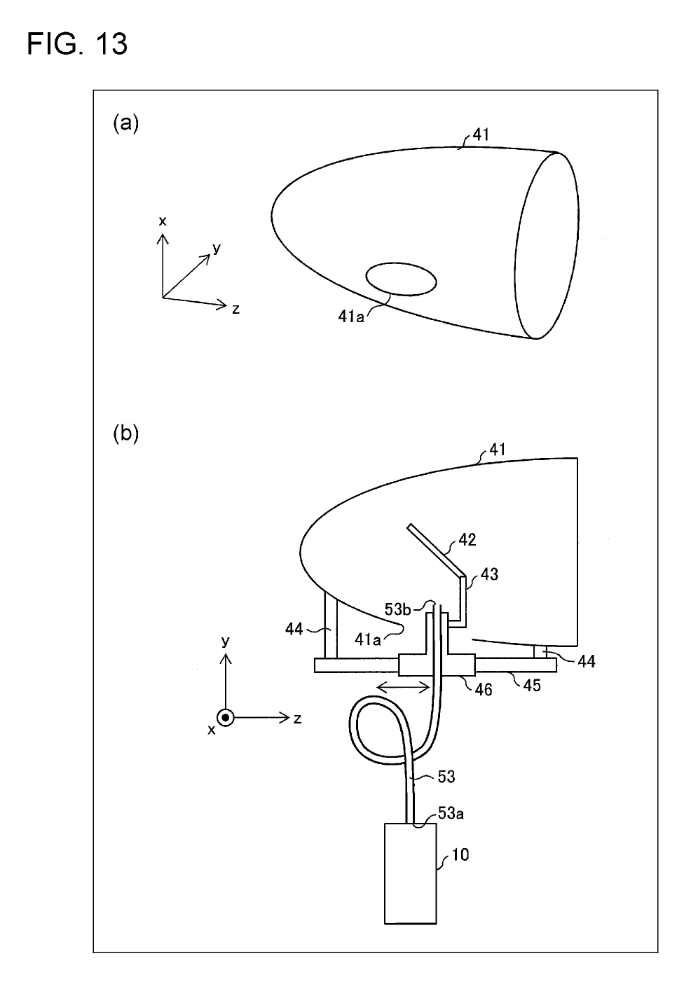

Another embodiment of the present invention will be described as follows with reference to FIG. 12 and FIG. 13. For simplifying the description, members having functions identical to those of the members described in the above embodiments are given identical reference characters, and descriptions thereof will be omitted.

<Configuration of Illumination Device 103>

With reference to FIG. 12, an illumination device 103 according to the present embodiment will be described. FIG. 12 is a schematic diagram illustrating a schematic configuration of the illumination device 103 according to the present embodiment.

The illumination device 103 is a device that can project a near-infrared laser beam and functions, for example, as an infrared projector that irradiates a dark place. As illustrated in FIG. 12, the illumination device 103 primarily includes a laser light source unit 10, a paraboloidal reflector 41 (projection member, reflector), a redirecting mirror 42, and an optical fiber 53 (diffusion member). The illumination device 103 guides near-infrared laser beams L1 emitted by respective infrared semiconductor laser elements 1 provided in the laser light source unit 10 through the inside of the optical fiber 53, diffuses the guided near-infrared laser beams L1, and projects diffused light L2 with the paraboloidal reflector 41.

(Laser Light Source Unit 10)

The laser light source unit 10 according to the present embodiment includes four infrared semiconductor laser elements 1. The four infrared semiconductor laser elements 1 emit the near-infrared laser beams L1 having mutually different peak wavelengths at an output power of 1 W, and the stated peak wavelengths are, for example, 780 nm, 790 nm, 800 nm, and 810 nm. Although the laser light source unit 10 according to the present embodiment includes four infrared semiconductor laser elements 1, the number of the infrared semiconductor laser elements 1 is not limited to four.

In addition, four condenser lenses 31 are disposed so as to oppose the respective infrared semiconductor laser elements 1.

(Paraboloidal Reflector 41)

The paraboloidal reflector 41 is a concave mirror that is disposed so as to oppose a radiation surface 53b of the optical fiber 53, that reflects the diffused light L2 radiated from the optical fiber 53, and that forms a pencil of rays (illumination light) that travels within a predetermined solid angle. In addition, the paraboloidal reflector 41 is a member that projects the diffused light L2 serving as the illumination light toward the outside of the illumination device 103 to image the diffused light L2. In other words, the paraboloidal reflector 41 images the distribution (light distribution) of the diffused light L2 on the radiation surface 53b of the optical fiber 53 onto a location at a desired distance.

The paraboloidal reflector 41 has a configuration similar to that of the paraboloidal reflector 17 according to Embodiment 2 except in that the shape of aperture portion of the paraboloidal reflector 41 is circular. For example, the paraboloidal reflector 41 is configured to be capable of moving in the directions indicated by the double-headed arrow in FIG. 12.

(Redirecting Mirror 42)

The redirecting mirror 42 reflects the near-infrared laser beams L1 (diffused light L2) diffused inside the optical fiber 53 and changes the optical axis of the diffused light L2 to be directed toward the paraboloidal reflector 41.

(Optical Fiber 53)

The optical fiber 53 is a member that does not include a fluorescent substance as a primary component, that diffuses the near-infrared laser beams L1 emitted by the infrared semiconductor laser elements 1, and that radiates the diffused near-infrared laser beams L1 as the diffused light L2.

In other words, the emission spectrum of the near-infrared laser beams L1 incident on the optical fiber 53 is substantially identical to the emission spectrum of the diffused light L2. Similarly to Embodiment 1, in these emission spectra, it is not necessary that all the spectral components be substantially identical.

The optical fiber 53 includes a light receiving surface 53a that receives the near-infrared laser beams L1 emitted by the infrared semiconductor laser elements 1 and the radiation surface 53b that is opposite to the light receiving surface 53a and that radiates the diffused light L2 toward the paraboloidal reflector 41. The four near-infrared laser beams L1 having different peak wavelengths emitted by the respective infrared semiconductor laser elements 1 are mixed inside the optical fiber 53 and radiated from the radiation surface 53b.

In addition, the optical fiber 53 is a waveguide member that guides the near-infrared laser beams L1 thereinside. Specifically, the optical fiber 53 is a multimode optical fiber with a core having a circular section. In this case, the diameter of the core of the optical fiber 53 is, for example, 800 μm, and the numerical aperture (N.A.) is, for example, 0.2.

As in the rod lens 52 according to Embodiment 3, the near-infrared laser beams L1 propagate inside of the optical fiber 53 while undergoing total reflection a plurality of times inside the optical fiber 53. Thus, the near-infrared laser beams L1 go out of phase while propagating inside of the optical fiber 53. Therefore, the optical fiber 53 can radiate the diffused light L2 in a state in which the temporal coherence of the near-infrared laser beams L1 is reduced.

In addition, the optical fiber 53 does not include a fluorescent substance as a primary component. This means, for example, that no less than 90% of the components constituting the optical fiber 53 is constituted by a component other than a fluorescent substance.

In addition, the area of the radiation surface 53b is larger than the area of the emission point of the infrared semiconductor laser elements 1. Therefore, the optical fiber 53 can radiate the diffused light L2 in a state in which the temporal coherence is reduced.

In other words, the illumination device 103 can radiate, from the radiation surface 53b, the diffused light L2 obtained by diffusing the near-infrared laser beams L1 by allowing the near-infrared laser beams L1 to pass through the inside of the optical fiber 53. In the illumination device 103, the radiation surface 53b on which the light spot is larger than the area of the emission point of the near-infrared laser beams L1 emitted by the infrared semiconductor laser elements 1 is regarded as an apparent light source. Then, the diffused L2 that is diffused as described above is radiated from this apparent light source, and the diffused light L2 is projected by the paraboloidal reflector 41.

In addition, according to the configuration described above, the optical fiber 53 can guide the diffused light L2 from the light receiving surface 53a to the radiation surface 53b and radiate the diffused light L2 from the side of the radiation surface 53b. Then, the diffused light L2 radiated from the side of the radiation surface 53b can be projected by the paraboloidal reflector 41. Accordingly, a so-called waveguide-type illumination device can be constructed as the illumination device 103.

It suffices that the optical fiber 53 be formed of a material that can transmit the near-infrared laser beams L1, and examples of such a material include glass, quartz, and resin such as plastics. In addition, the optical fiber 53 may be a photonic crystal fiber. In addition, it is not necessary that the sectional shape of the optical fiber 53 be circular, and the sectional shape may be any desired shape, such as a rectangle. In other words, it suffices that the optical fiber 53 be made of a material and have a shape that can guide the near-infrared laser beams L1.

In addition, the optical fiber 53 does not include a fluorescent substance as a primary component. This means, for example, that it suffices that, of the components constituting the optical fiber 53, no less than 90% of the of the optical fiber 53 be constituted by a component other than a fluorescent substance.

(Changing Mechanism)

In addition, the illumination device 103 includes, aside from the members described above, a changing mechanism that changes the relative position between the optical fiber 53 and the paraboloidal reflector 41. Hereinafter, with reference to FIG. 13, the changing mechanism will be described. FIG. 13 is a diagram for describing an example of the changing mechanism.

As illustrated in (a) of FIG. 13, a through-hole 41a is formed in the bottom portion of the paraboloidal reflector 41 (the surface that opposes the changing mechanism). The through-hole 41a is a cut-out portion that makes it possible to move the paraboloidal reflector 41 in the ±z-axis directions in a state in which the redirecting mirror 42 and the optical fiber 53 fixed to a slide portion 46 of the changing mechanism are disposed inside the paraboloidal reflector 41 (refer to (b) of FIG. 13).

As illustrated in (b) of FIG. 13, the changing mechanism primarily includes a guide portion 45 and the slide portion 46 and is of a slider type in which the slide portion 46 slides on the guide portion 45.

Similarly to the guide portion 21 according to Embodiment 2, the guide portion 45 is a rail-like member that enables the slide portion 46 fitted thereon to move in the ±z-axis directions. Thus, the guide portion 45 is disposed so as to extend in the +z-axis direction (the direction in which the diffused light L2 is projected) on the surface of a support stand (not illustrated) to which the guide portion 45 is fixed. The guide portion 45 may be a portion of the aforementioned support stand.

Similarly to the slide portion 22 according to Embodiment 2, the slide portion 46 is fitted on the guide portion 45 and is configured to be capable of moving in the direction in which the guide portion 45 extends (the directions indicated by the double-headed arrow in FIG. 13) as being slid on the guide portion 45. This movement may be controlled manually or electrically with an actuator or a motor (neither is illustrated), and a well-known technique can be employed.

A through-hole is formed in the vicinity of the center of the slide portion 46. The optical fiber 53 can be moved along with the slide portion 46 by placing and fixing the optical fiber 53 in the aforementioned through-hole.

In addition, a through-groove is formed in the vicinity of the center of the guide portion 45 in the lengthwise direction. This through-groove is formed so as to oppose the through-hole in the slide portion 46 fitted on the guide portion 45. With this configuration, the optical fiber 53 can be moved along with the movement of the slide portion 46.

(Peripheral Members of Changing Function)

Aside from the above, the illumination device 103 includes a mirror support member 43 and a reflector support member 44.

The mirror support member 43 is a member that fixes the redirecting mirror 42 to the slide portion 46 such that the radiation surface 53b of the optical fiber 53 fixed in the through-hole in the slide portion 46 opposes the reflective surface of the redirecting mirror 42.

The reflector support member 44 is attached to the guide portion 45 and is a member that supports the paraboloidal reflector 41. In other words, the paraboloidal reflector 41 is fixed to the guide portion 45 with the reflector support member 44.

Therefore, the redirecting mirror 42 and the optical fiber 53 can be moved relative to the paraboloidal reflector 41 while the relative positional relationship of the redirecting mirror 42 and the optical fiber 53 is fixed.

(Advantageous Effect of Changing Mechanism)

Thus, similarly to Embodiment 2, the relative position between the optical fiber 53 and the paraboloidal reflector 41 can be adjusted. Therefore, by adjusting the stated relative position, the diffused light L2 can, for example, be projected by the paraboloidal reflector 41 upon having been substantially collimated. In this case, the illumination device 103 can project the diffused light L2 over a long distance. In other words, the illumination device 103 can be used as a lamp for observing a dark place that can observe a target in a location at a long distance.

In order to project the diffused light L2 over a long distance, it is preferable that the stated relative position be defined such that the maximum angle of the angle (divergence angle) formed by the line perpendicular (z-axis) to the aperture surface of the paraboloidal reflector 41 and the diffused light L2 radiated from the paraboloidal reflector 41 is small. As long as the stated relative position is defined in this manner, the relative position may be fixed. In this case, the changing mechanism does not need to be provided.

<Primary Advantageous Effect of Illumination Device 103>

Similarly to Embodiments 1 to 3, the illumination device 103 diffuses the near-infrared laser beams L1 with the optical fiber 53 and projects the diffused light L2. Therefore, the diffused light L2 can be projected in a state in which the temporal and spatial coherences are reduced, and an occurrence of a moire-like projected image can be suppressed. In addition, a highly safe illumination device can be provided.

### Embodiment 5

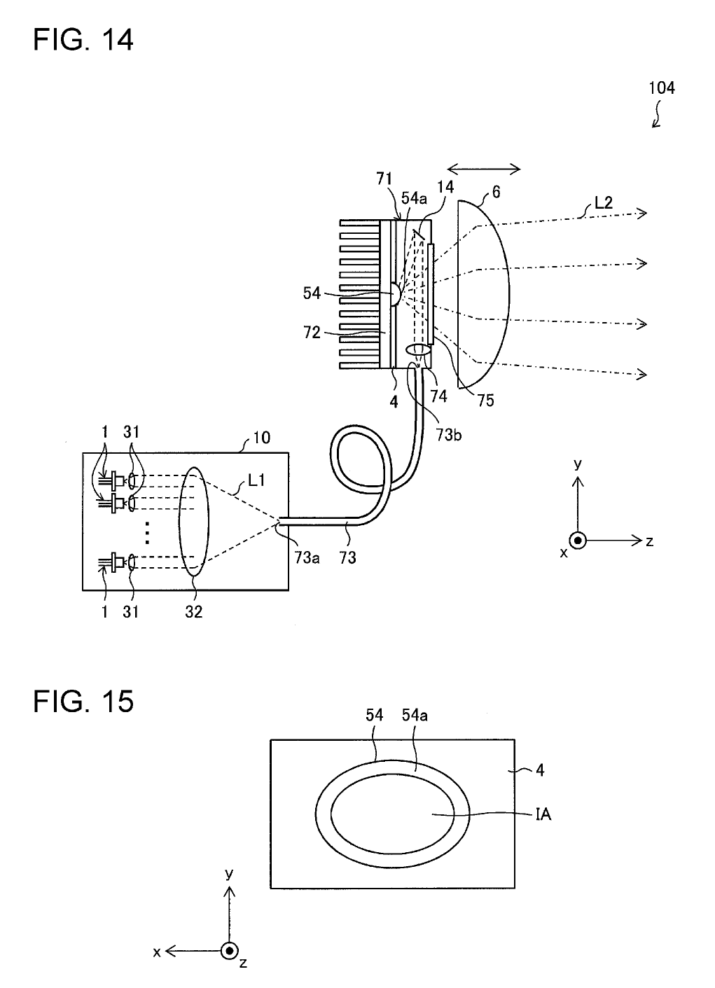

Another embodiment of the present invention will be described as follows with reference to FIG. 14 to FIG. 16. For simplifying the description, members having functions identical to those of the members described in the above embodiments are given identical reference characters, and descriptions thereof will be omitted.

With reference to FIG. 14, an illumination device 104 according to the present embodiment will be described. FIG. 14 is a schematic diagram illustrating a schematic configuration of the illumination device 104 according to the present embodiment. The double-headed arrow illustrated in FIG. 14 indicates the direction in which a projection lens 6 can move.

The illumination device 104 is a device that can project a near-infrared laser beam and functions, for example, as an infrared projector that irradiates a dark place. As illustrated in FIG. 14, the illumination device 104 primarily includes a light absorbing member 4, the projection lens 6, a laser light source unit 10, a reflection mirror 14, a diffusion member 54, a housing 71, a support stand 72, an optical fiber 73, a condenser lens 74, and a window member 75.

(Laser Light Source Unit 10)

The laser light source unit 10 according to the present embodiment includes ten infrared semiconductor laser elements 1. The ten infrared semiconductor laser elements 1 each emit a near-infrared laser beam L1 having a peak wavelength of, for example, 810 nm at an output power of 0.5 W. Although the laser light source unit 10 according to the present embodiment includes ten infrared semiconductor laser elements 1, the number of the infrared semiconductor laser elements 1 is not limited to ten.

In addition, ten condenser lenses 31 are disposed so as to oppose the respective infrared semiconductor laser elements 1.

In addition, it is preferable that the near-infrared laser beams L1 impinge on a light receiving surface 54a such that irradiation regions IA (refer to FIG. 15) of the respective near-infrared laser beams L1 overlap each other. Therefore, in the present embodiment, the plurality of near-infrared laser beams L1 are guided to a single optical fiber 73. With this configuration, the irradiation region IA, or in other words, the radiation region of diffused light L2 can be made small. Therefore, the diffusion member 54 can be regarded as a point light source, and thus the diffused light L2 can be projected over a long distance.

(Housing 71)

The housing 71 is a member that supports the reflection mirror 14, the condenser lens 74, and the window member 75 and is fixed to the support stand 72 so as to cover the light absorbing member 4 and the diffusion member 54 that are disposed on the surface of the support stand 72.

(Support Stand 72)

The support stand 72 is a member that supports at least the diffusion member 54. The material of the support stand 72 is similar to that of the support stand 3. The support stand 72 is processed as a heat-dissipating fin.

(Optical Fiber 73)

The optical fiber 73 is a waveguide member that guides the near-infrared laser beams L1 transmitted through a condenser lens 32 to the vicinity of the condenser lens 74. The optical fiber 73 is, for example, a multimode optical fiber with a core having a circular section, but any type of optical fiber that can guide the near-infrared laser beams L1 to the vicinity of the condenser lens 74 may be used.

The optical fiber 73 includes a light receiving surface 73a that receives the near-infrared laser beams L1 and a radiation surface 73b through which the near-infrared laser beams L1 that have entered through the light receiving surface 73a are radiated.

(Condenser Lens 74)

The condenser lens 74 is disposed between the radiation surface 73b of the optical fiber 73 and the reflection mirror 14 and is a member that substantially collimates the near-infrared laser beams L1 radiated from the radiation surface 11b and condenses the near-infrared laser beams L1 on the reflection mirror 14. The condenser lens 74 is constituted, for example, by a convex lens made of glass.

(Window Member 75)

The window member 75 is a member that transmits the diffused light L2 radiated from the diffusion member 54 and is formed, for example, of glass. The material of the window member 75 may be any material that can transmit the diffused light L2.

(Diffusion Member 54)

The diffusion member 54 is a member that includes a light diffusing element that does not include a fluorescent substance as a primary component, that diffuses the near-infrared laser beams L1 emitted by the infrared semiconductor laser elements 1 with the light diffusing element, and that radiates the diffused near-infrared laser beams L1 as the diffused light L2. To rephrase, the diffusion member 54 is a member that does not include a fluorescent substance as a primary component.

In other words, the emission spectrum of the near-infrared laser beams L1 incident on the diffusion member 54 is substantially identical to the emission spectrum of the diffused light L2. Similarly to Embodiment 1, in these emission spectra, it is not necessary that all the spectral components be substantially identical.

The diffusion member 54 includes the light receiving surface 54a that receives the near-infrared laser beams L1 emitted by the infrared semiconductor laser elements 1, and fine concavities and convexities (rough surface) are formed in the light receiving surface 54a. With this configuration, the diffusion member 54 can efficiently diffuse the near-infrared laser beams L1 and radiate the diffused light L2 in a state in which the spatial coherence of the near-infrared laser beams L1 is reduced. The arithmetic mean roughness of the light receiving surface 54a in which the fine concavities and convexities are formed is similar to that of the light receiving surface 5a according to Embodiment 1.

In other words, according to the present embodiment, the fine concavities and convexities formed in the light receiving surface 54a of the diffusion member 54 correspond to the light diffusing element.

In addition, the expression that the light diffusing element of the diffusion member 54 does not include a fluorescent substance as a primary component means that the proportion of the fluorescent substance with respect to the area of the light receiving surface 54a is no more than 10% in the present embodiment. The expression may also mean that it suffices that, of the components constituting the diffusion member 54, no less than 90% of the light diffusing element of the diffusion member 54 is constituted by a component other than a fluorescent substance.

In addition, it suffices that the light diffusing element that does not include a fluorescent substance as a primary component (the fine concavities and convexities described above) be formed at least only in the irradiation region of the near-infrared laser beams L1 formed on the light receiving surface 54a, and regions other than the stated irradiation region may include a fluorescent substance in a proportion no less than the proportion described above. In other words, it suffices that a fluorescent substance be scarcely present at least in the irradiation region of the near-infrared laser beams L1.

In addition, the diffusion member 54 is not plate-shaped but has a dome shape in which the center portion of the light receiving surface 54a is higher (thicker) than the peripheral portion thereof and the bottom surface is elliptical in shape. With this configuration, the diffused light L2 with a higher optical intensity can be radiated at broader angles as compared to the case in which the light receiving surface of the diffusion member is planar.

As illustrated in FIG. 15, the near-infrared laser beams L1 impinge on the vicinity of the center of the light receiving surface 54a of the diffusion member 54 and form an irradiation region IA on the light receiving surface 54a. FIG. 15 is a diagram illustrating a state in which the light receiving surface 54a of the diffusion member 54 is irradiated with the near-infrared laser beams L1, as viewed from the +z-axis direction into the −z-axis direction. Similarly to Embodiment 1, in the present embodiment, the near-infrared laser beams L1 impinge on the diffusion member 54 such that the irradiation region IA is elliptical in shape. The size and the position of the irradiation region IA on the light receiving surface 54a can be adjusted by the relative positional relationship of the reflection mirror 14, the diffusion member 54, and the condenser lens 74 and by the optical characteristics (reflectance, refractive index, and so on) of the condenser lens 74.

In addition, the diffusion member 54 diffuses the near-infrared laser beams L1 emitted by the infrared semiconductor laser elements 1 at the light receiving surface 54a and radiates the diffused light L2 obtained by diffusing the near-infrared laser beams L1 toward the projection lens 6. Accordingly, similarly to Embodiment 1, a so-called reflection-type illumination device can be constructed as the illumination device 104.

The diffusion member 54 is formed, for example, of ceramics, but this is not a limiting example, and it is preferable that the diffusion member 54 be formed of a material having a high reflectance with respect to the wavelength of the near-infrared laser beams L1, such as alumina or barium sulfate. In this case, the diffused light L2 can be directed efficiently toward the projection lens 6. In addition, as the reflectance of the material is higher, the utilization efficiency of the near-infrared laser beams L1 can be increased. Furthermore, it is preferable that the diffusion member 54 be formed of a nontransparent material having high thermal conductivity. In this case, heat produced through irradiation with the near-infrared laser beams L1 can be dissipated efficiently to the outside. It is not necessary that the entirety of the diffusion member 54 be formed of metal, and it suffices that at least the light receiving surface 54a be formed of metal.

(How Diffused Light L2 is Radiated)

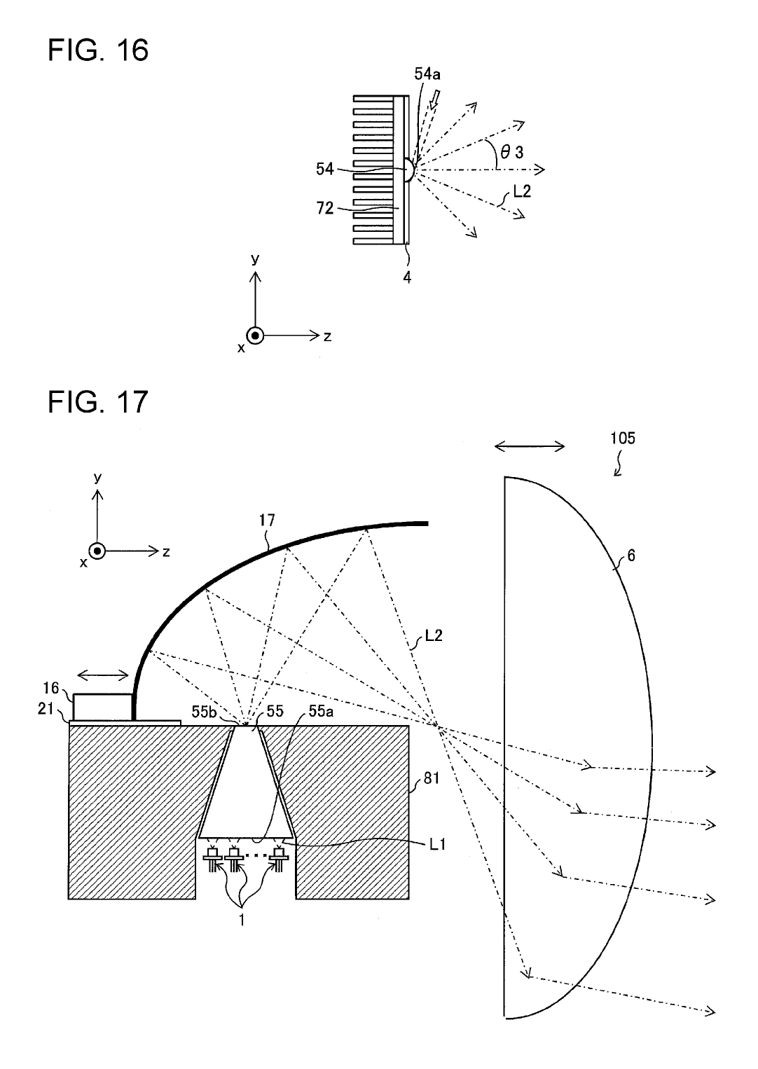

Next, with reference to FIG. 16, how the near-infrared laser beams L1 are diffused by the diffusion member 54 (i.e., how the diffused light L2 is radiated) as viewed from the +x-axis direction into the −x-axis direction will be described. FIG. 16 is a diagram illustrating how the diffused light L2 is radiated.

As illustrated in FIG. 16, the near-infrared laser beams L1 condensed on the light receiving surface 54a of the diffusion member 54 are diffused isotropically by the fine concavities and convexities provided in the light receiving surface 54a. In addition, the light receiving surface 54a has a shape in which the height of the center portion is greater than the height of the peripheral portion.

In this case, when the angle of inclination of the line perpendicular to the light receiving surface 54a is represented by θ3, the distribution of the diffused light L2 becomes an emission distribution in which, as compared to the Lambertian distribution, the optical intensity becomes greater than the optical intensity of the Lambertian distribution as θ3 increases. Therefore, the optical intensity of the diffused light L2 in a region in which θ3 is close to 90° or −90° (the region in the vicinity of the light receiving surface 54a) is greater than the optical intensity of the diffused light L2 in the stated region in the Lambertian distribution. Thus, the diffused light L2 with a higher optical intensity can be radiated at broader angles as compared to the Lambertian distribution.

In the illumination device 104 according to the present embodiment, the light spot formed on the diffusion member 54 that is larger than the area of the emission point of the near-infrared laser beams L1 emitted by the infrared semiconductor laser elements 1 is regarded as an apparent light source. Then, the diffused light L2 that is diffused as described above is radiated from this apparent light source, and the diffused light L2 is projected by the projection lens 6.

(Changing Mechanism)

In addition, the illumination device 104 includes, aside from the members described above, a changing mechanism that changes the relative position between the diffusion member 54 and the projection lens 6. With this configuration, similarly to Embodiment 1, the relative position between the diffusion member 54 and the projection lens 6 can be adjusted, and the diffused light L2 can be projected over a long distance. Aside from the above, the configuration and the advantageous effect of the changing mechanism have been described in Embodiment 1, and thus descriptions thereof will be omitted in the present embodiment.

<Primary Advantageous Effect of Illumination Device 104>

Similarly to Embodiments 1 to 4, the illumination device 104 diffuses the near-infrared laser beams L1 with the diffusion member 54 and projects the diffused light L2. Therefore, the diffused light L2 can be projected in a state in which the spatial coherence is reduced, and an occurrence of a moire-like projected image can be suppressed. In addition, a highly safe illumination device can be provided.

### Embodiment 6

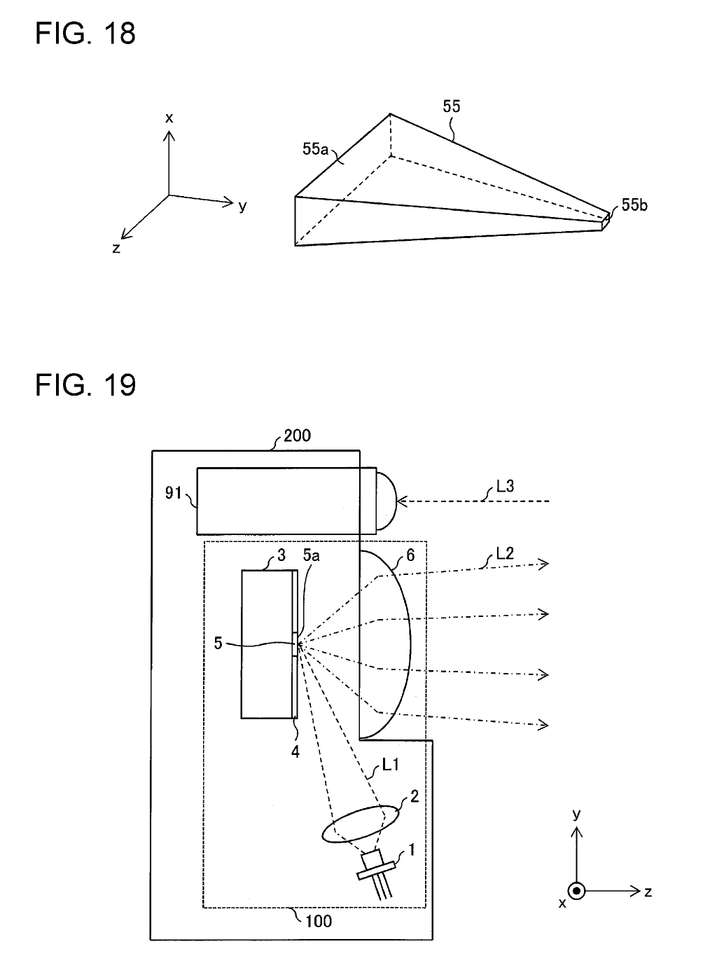

Another embodiment of the present invention will be described as follows with reference to FIG. 17 and FIG. 18. For simplifying the description, members having functions identical to those of the members described in the above embodiments are given identical reference characters, and descriptions thereof will be omitted.

With reference to FIG. 17, an illumination device 105 according to the present embodiment will be described. FIG. 17 is a schematic diagram illustrating a schematic configuration of the illumination device 105 according to the present embodiment. The double-headed arrow illustrated in FIG. 17 indicates the directions in which a projection lens 6 and a paraboloidal reflector 17 can move.

The illumination device 105 is a device that can emit a near-infrared laser beam and functions, for example, as an infrared projector that irradiates a dark place. As illustrated in FIG. 17, the illumination device 105 primarily includes infrared semiconductor laser elements 1, the projection lens 6, a reflector support member 16, the paraboloidal reflector 17, a guide portion 21, a tapering waveguide member 55 (diffusion member), and a housing 81. The illumination device 105 guides near-infrared laser beams L1 emitted by the respective infrared semiconductor laser elements 1 through the inside of the tapering waveguide member 55, diffuses the guided near-infrared laser beams L1, and projects diffused light L2 with the projection lens 6.

(Infrared Semiconductor Laser Element 1)

The infrared semiconductor laser elements 1 according to the present embodiment each emit a near-infrared laser beam L1 having a peak wavelength of, for example, 820 nm at an output power of 0.5 W. In addition, the illumination device 105 according to the present embodiment includes six infrared semiconductor laser elements 1, but the number of the infrared semiconductor laser elements 1 is not limited to six.

(Paraboloidal Reflector 17)

The paraboloidal reflector 17 has a function similar to that of the paraboloidal reflector 17 according to Embodiment 2, but the diffused light L2 reflected by the paraboloidal reflector 17 is incident on the projection lens 6. In other words, in the present embodiment, the projection lens 6 functions as the projection member. Both the projection lens 6 and the paraboloidal reflector 17 may be regarded as the projection members.

(Tapering Waveguide Member 55)

The tapering waveguide member 55 is a member that does not include a fluorescent substance as a primary component, that diffuses the near-infrared laser beams L1 emitted by the infrared semiconductor laser elements 1, and that radiates the diffused near-infrared laser beams L1 as the diffused light L2.

In other words, the emission spectrum of the near-infrared laser beams L1 incident on the tapering waveguide member 55 is substantially identical to the emission spectrum of the diffused light L2. Similarly to Embodiment 1, in these emission spectra, it is not necessary that all the spectral components be substantially identical.

In addition, the tapering waveguide member 55 includes a light receiving surface 55a that receives the near-infrared laser beams L1 emitted by the infrared semiconductor laser elements 1 and a radiation surface 55b that is opposite to the light receiving surface 55a and that radiates the diffused light L2 toward the projection lens 6. Furthermore, as illustrated in FIG. 18, the tapering waveguide member 55 has a tapering shape in which the size of the section perpendicular to the optical axis (y-axis) decreases from the light receiving surface 55a toward the radiation surface 55b.

With such a tapering shape, the near-infrared laser beams L1 incident on the light receiving surface 55a are reflected by the inner wall of the tapering waveguide member 55 and randomly mixed together while being guided. In addition, the area of the radiation surface 55b is sufficiently larger than the area of the emission point of the infrared semiconductor laser elements 1. Therefore, the tapering waveguide member 55 can radiate the diffused light L2 in a state in which the temporal coherence of the near-infrared laser beams L1 is reduced.

In other words, the illumination device 105 can radiate, from the radiation surface 55b, the diffused light L2 obtained by diffusing the near-infrared laser beams L1 by allowing the near-infrared laser beams L1 to pass through the inside of the tapering waveguide member 55. In addition, the tapering waveguide member 55 mixes the near-infrared laser beams L1 randomly, and thus the light distribution of the diffused light L2 can be made substantially uniform within the plane of the radiation surface 55b. In the illumination device 105, the radiation surface 55b on which the light spot is larger than the area of the emission point of the near-infrared laser beams L1 emitted by the infrared semiconductor laser elements 1 is regarded as an apparent light source. Then, the diffused light beam L2 that is diffused with the light distribution being made substantially uniform as described above is radiated from this apparent light source, and the diffused light L2 is projected by the projection lens 6.

In addition, according to the configuration described above, the tapering waveguide member 55 can guide the diffused light L2 from the light receiving surface 55a to the radiation surface 55b and radiate the diffused light L2 from the side of the radiation surface 55b. Then, the diffused light L2 radiated from the side of the radiation surface 55b can be projected by the projection lens 6 via the paraboloidal reflector 17. Accordingly, a so-called waveguide-type illumination device can be constructed as the illumination device 105.

In addition, the tapering waveguide member 55 does not include a fluorescent substance as a primary component. This means, for example, that no less than 90% of the components constituting the tapering waveguide member 55 is constituted by a component other than a fluorescent substance.

It suffices that the tapering waveguide member 55 be formed of a material that can transmit the near-infrared laser beams L1, and examples of such a material include glass, quartz, and resin such as plastics. In addition, it is not necessary that the tapering waveguide member 55 is prismoidal in shape, and the tapering waveguide member 55 may, for example, have a truncated cone shape. In other words, it suffices that the tapering waveguide member 55 be made of a material and have a shape that can guide the near-infrared laser beams L1.

(Housing 81)

The housing 81 is a member that houses the infrared semiconductor laser elements 1 and the tapering waveguide member 55. Specifically, formed inside the housing 81 is a path that guides the near-infrared laser beams L1 emitted by the infrared semiconductor laser elements 1 to the tapering waveguide member 55 and that allows the diffused light L2 to be radiated from the tapering waveguide member 55 toward the paraboloidal reflector 17. Then, the infrared semiconductor laser elements 1 and the tapering waveguide member 55 are fixed in that path. In addition, a material similar to that of the housing 15 according to Embodiment 2 can be used as the material of the housing 81.

(Changing Mechanism)

In addition, the illumination device 105 includes, aside from the members described above, a changing mechanism (first changing mechanism) that changes the relative position between the tapering waveguide member 55 and the projection lens 6. With this configuration, similarly to Embodiment 1, the relative position between the tapering waveguide member 55 and the projection lens 6 can be adjusted, and the diffused light L2 can be projected over a long distance.

Similarly to Embodiment 2, the illumination device 105 may include a changing mechanism (second changing mechanism) that changes the relative position between the tapering waveguide member 55 and the paraboloidal reflector 17. In this case, the relative position between the tapering waveguide member 55 and the paraboloidal reflector 17 can be adjusted as well, and a finer adjustment can be made with the two changing mechanisms.

In addition, the configuration may be such that the illumination device 105 includes the second changing mechanism in place of the first changing mechanism. Furthermore, as described in Embodiments 1 and 2, the first changing mechanism and the second changing mechanism do not need to be provided when the aforementioned relative positions do not need to be changed.

Aside from the above, the configurations and the advantageous effects of the changing mechanisms have been described in Embodiments 1 and 2, and thus descriptions thereof will be omitted in the present embodiment.

<Primary Advantageous Effect of Illumination Device 105>

Similarly to Embodiments 1 to 5, the illumination device 105 diffuses the near-infrared laser beams L1 with the tapering waveguide member 55 and projects the diffused light L2. Therefore, the diffused light L2 can be projected in a state in which the spatial coherence is reduced, and an occurrence of a moire-like projected image can be suppressed. In addition, a highly safe illumination device can be provided.

### Embodiment 7

Another embodiment of the present invention will be described as follows with reference to FIG. 19. For simplifying the description, members having functions identical to those of the members described in the above embodiments are given identical reference characters, and descriptions thereof will be omitted.

<Configuration of Observation System 200>

With reference to FIG. 19, an observation system 200 according to the present embodiment will be described. FIG. 19 is a schematic diagram illustrating a schematic configuration of the observation system 200 according to the present embodiment.

The observation system 200 is a system that can detect and observe a target present in front of the observation system 200 and primarily includes an infrared camera 91 (imaging device) and an illumination device 100, as illustrated in FIG. 19. Although a case in which the observation system 200 includes the illumination device 100 is described in the present embodiment, this is not a limiting example, and the observation system 200 can include any of the illumination devices 101 to 105 described above.

(Infrared Camera 91)

The infrared camera 91 is an imaging device that captures a projected image formed as a target (not illustrated) is irradiated with the diffused light L2 diffused by the diffusion member 5 and emitted from the illumination device 100. Upon the target being irradiated with the diffused light L2, the diffused light L2 is reflected by the surface of the target and is incident on the infrared camera 91 as reflected light L3. The infrared camera 91 receives the reflected light L3 and thus captures the projected image.

<Primary Advantageous Effect of Observation System 200>

Since the observation system 200 includes the illumination device 100 according to Embodiment 1, an occurrence of a moire-like projected image can be suppressed even though an infrared semiconductor laser element is used as the light source. Therefore, the observation system 200 can acquire, with the infrared camera 91, a projected image in which the state of the target, such as the shape or the pattern, is accurately reflected. In addition, a highly safe observation system can be provided.

The observation system 200 also provides a similar advantageous effect in a case in which the observation system 200 includes any of the illumination devices 101 to 105 according to Embodiments 2 to 6, respectively.

[Supplementary Matters]

In the illumination devices 100 to 105, when a plurality of infrared semiconductor laser elements 1 are provided, the peak wavelengths of the near-infrared laser beams L1 emitted by the respective infrared semiconductor laser elements 1 may be the same as or differ from each other. In other words, the numerical values of the peak wavelengths illustrated in each of the embodiments are merely examples.

In a case in which the peak wavelengths of the near-infrared laser beams L1 differ from each other, when the near-infrared laser beams L1 are mixed, the temporal coherence of the mixed laser beams decreases. Therefore, an occurrence of a moire-like projected image can be further suppressed.

[Recapitulation]

An illumination device (100 to 105) according to a first aspect of the present invention includes

a laser light source (infrared semiconductor laser element 1) that emits only a near-infrared laser beam,

a diffusion member (diffusion member 5, 51, rod lens 52, optical fiber 53, diffusion member 54, tapering waveguide member 55) that does not include a fluorescent substance as a primary component and that diffuses the near-infrared laser beam (L1), and

a projection member (projection lens 6, paraboloidal reflector 17, 41) that projects the near-infrared laser beam (diffused light L2) diffused by the diffusion member.

According to the above configuration, the near-infrared laser beam emitted by the laser light source is diffused by the diffusion member. The projection member projects the near-infrared laser beam diffused by the diffusion member. Therefore, even in a case in which a laser light source serving as a high-power light source is used in order to project near-infrared light over a long distance, the near-infrared laser beam can be projected substantially uniformly, and thus an occurrence of a moire-like projected image can be suppressed.

In addition, the diffusion member does not include a fluorescent substance as a primary component. The illumination device according to an aspect of the present embodiment diffuses and projects a near-infrared laser beam and neither excite a near-infrared laser beam nor emit visible light by exciting a laser beam having a peak wavelength different from that of a near-infrared laser beam. Therefore, the diffusion member does not need to include a fluorescent substance as a primary component, and thus the diffusion member can be designed with ease. Therefore, the illumination device according to an aspect of the present invention can be manufactured with ease as compared to an illumination device that includes a diffusion member that includes a fluorescent substance as a primary component.

Furthermore, in an illumination device according to a second aspect of the present invention, it is preferable that, in the first aspect,

the near-infrared laser beam have a peak wavelength in a wavelength band of no shorter than 740 nm nor longer than 1000 nm.

According to the above configuration, the illumination device according to an aspect of the present invention can diffuse and project a near-infrared laser beam having a peak wavelength in a wavelength band of no shorter than 740 nm nor longer than 1000 nm.

Furthermore, it is preferable that an illumination device according to a third aspect of the present invention include, in the first or second aspect,

a plurality of the laser light sources and

laser beams emitted by the respective laser light sources have mutually different peak wavelengths.

According to the above configuration, in a case in which the peak wavelengths mutually differ, when these laser beams are mixed, the temporal coherence of the mixed laser beams decreases. Therefore, an occurrence of a moire-like projected image can be further suppressed.

Furthermore, in an illumination device according to a fourth aspect of the present invention, it is preferable that, in any one of the first to third aspects,

the diffusion member (5, 54) include a light receiving surface (5a, 54a) that receives the near-infrared laser beam and

the light receiving surface be a rough surface.

According to the above configuration, since the light receiving surface that receives the near-infrared laser beam is a rough surface, the diffusion member can efficiently diffuse the near-infrared laser beam incident on the light receiving surface.

Furthermore, in an illumination device according to a fifth aspect of the present invention, it is preferable that, in the fourth aspect,

the diffusion member diffuse the near-infrared laser beam at the light receiving surface and radiate the near-infrared laser beam toward the projection member.

According to the above configuration, the diffusion member can diffuse the near-infrared laser beam incident on the light receiving surface and radiate the near-infrared laser beam from the side of the light receiving surface (the side on which the near-infrared laser beam is incident). Then, the diffused near-infrared laser beam radiated from the side of the light receiving surface can be projected by the projection member.

Furthermore, in an illumination device according to a sixth aspect of the present invention, it is preferable that, in the fourth or fifth aspect,

at least the light receiving surface of the diffusion member be made of metal.

According to the above configuration, the near-infrared laser beam incident on the light receiving surface can be efficiently reflected.

Furthermore, in an illumination device according to a seventh aspect of the present invention, it is preferable that, in any one of the first to third aspects,

the diffusion member include
a light receiving surface (51a, 52a, 53a, 55a) that receives the near-infrared laser beam and
a radiation surface (radiation surface 51b, 52b, 53b, 55b) that is opposite to the light receiving surface and that radiates the diffused near-infrared laser beam toward the projection member.

According to the above configuration, the diffusion member can diffuse the near-infrared laser beam incident on the light receiving surface and radiate the diffused near-infrared laser beam from the side of the radiation surface that is opposite to the light receiving surface. Then, the diffused near-infrared laser beam radiated from the side of the radiation surface can be projected by the projection member.

Furthermore, in an illumination device according to an eighth aspect of the present invention, it is preferable that, in the seventh aspect,

at least one of the light receiving surface and the radiation surface be a rough surface.

According to the above configuration, when the light receiving surface that receives the near-infrared laser beam is a rough surface, the diffusion member can efficiently diffuse the near-infrared laser beam incident on the light receiving surface. In addition, when the radiation surface that radiates the diffused near-infrared laser beam is a rough surface, the diffusion member can efficiently diffuse, at the radiation surface, the near-infrared laser beam that has been incident on the light receiving surface and has reached the radiation surface.

Furthermore, in an illumination device according to a ninth aspect of the present invention, it is preferable that, in the seventh or eighth aspect,

the diffusion member (51) be a member that can transmit the near-infrared laser beam or the diffused near-infrared laser beam.

According to the above configuration, the near-infrared laser beam received by the light receiving surface or the near-infrared laser beam diffused as the light receiving surface can be made to reach the radiation surface.

Furthermore, in an illumination device according to a tenth aspect of the present invention, it is preferable that, in the seventh aspect,

the diffusion member be a waveguide member (rod lens 52, optical fiber 53, tapering waveguide member 55) that guides the near-infrared laser beam thereinside.

According to the above configuration, the diffusion member can diffuse the near-infrared laser beam and radiate the near-infrared laser beam from the radiation surface.

Furthermore, in an illumination device according to an eleventh aspect of the present invention, it is preferable that, in the tenth aspect,

the diffusion member be an optical fiber (53).

According to the above configuration, the near-infrared laser beam received at the light receiving surface undergoes total reflection inside the optical fiber, and thus the near-infrared laser beam goes out of phase while propagating inside the optical fiber. Therefore, the near-infrared laser beam can be diffused and radiated upon having propagated inside of the optical fiber.

Furthermore, in an illumination device according to a twelfth aspect of the present invention, it is preferable that, in the tenth aspect,

the diffusion member be a rod lens (52).

According to the above configuration, similarly to the eleventh aspect described above, the near-infrared laser beam goes out of phase while propagating inside the rod lens. Therefore, the near-infrared laser beam can be diffused and radiated upon having propagated inside of the optical fiber.

Furthermore, in an illumination device according to a thirteenth aspect of the present invention, it is preferable that, in the tenth aspect,

the diffusion member (tapering waveguide member 55) have a tapering shape in which the size of a section perpendicular to an optical axis decreases from the light receiving surface (55a) toward the radiation surface (55b).

According to the above configuration, the diffusion member having a tapering shape can diffuse and radiate the near-infrared laser beam.

Furthermore, it is preferable that, in the thirteenth aspect, an illumination device according to a fourteenth aspect of the present invention include

a plurality of the laser light sources and

the near-infrared laser beams emitted by the respective laser light sources be each guided by the diffusion member.

According to the above configuration, the near-infrared laser beams emitted by the respective laser light sources can be mixed randomly and easily while propagating inside the diffusion member having a tapering shape.

Furthermore, it is preferable that, in any one of the first through ninth aspects, an illumination device according to a fifteenth aspect of the present invention include

a plurality of the laser light sources,

the diffusion member (5, 51, 54) include a light receiving surface (5a, 51a, 54a) that receives the near-infrared laser beam, and

the plurality of laser light sources emit the respective near-infrared laser beams toward the light receiving surface such that irradiation regions (IA) formed by the respective near-infrared laser beams on the light receiving surface overlap each other.

According to the above configuration, the light receiving surface can be irradiated with the near-infrared laser beams emitted by the respective laser light sources, and thus the diffusion member can diffuse each of the near-infrared laser beams. In addition, the near-infrared laser beams impinge on the light receiving surface such that the respective irradiation regions overlap each other, and thus the radiation point of the diffused near-infrared laser beams radiated from the diffusion member can be made small. Therefore, the diffusion member can be regarded as a point light source, and thus the illumination device according to an aspect of the present invention can project the diffused near-infrared laser beam over a long distance.

Furthermore, in an illumination device according to a sixteenth aspect of the present invention, it is preferable that, in any one of the first to fifteenth aspects,

the projection member be a lens (projection lens 6) that transmits the near-infrared laser beam diffused by the diffusion member.

According to the above configuration, the light can be projected by using the lens.

Furthermore, in an illumination device according to a seventeenth aspect of the present invention, it is preferable that, in any one of the first to fifteenth aspects,

the projection member be a reflector (paraboloidal reflector 17, 41) that reflects the near-infrared laser beam diffused by the diffusion member.

According to the above configuration, the light can be projected by using the reflector.

Furthermore, it is preferable that, in any one of the first to seventeenth aspects, an illumination device according to an eighteenth aspect of the present invention include

a changing mechanism that changes the relative position between the diffusion member and the projection member.

According to the above configuration, the relative position can be changed. For example, the relative position can be adjusted such that the diffused near-infrared laser beam is substantially collimated, and the near-infrared laser beam can be projected from the projection member. In this case, the illumination device according to an aspect of the present invention can project the near-infrared laser beam over a long distance.

Furthermore, it is preferable that an observation system (200) according to a nineteenth aspect of the present invention include

the illumination device (100 to 105) according to any one of the first to eighteenth aspects, and

an imaging device (infrared camera 91) that captures a projected image formed as a target is irradiated with the near-infrared laser beam diffused by the diffusion member and projected by the illumination device.

According to the above configuration, a projected image formed as a target is irradiated with the diffused near-infrared laser beam can be captured. In addition, since the diffused near-infrared laser beam is projected, a moire-like projected image can be prevented from being captured. Therefore, the imaging device can acquire an image in which the shape or the pattern of the target is reflected accurately.

[Others]

An illumination device according to the present application can also be expressed as follows.

For example, an illumination device according to the present application is a projector that includes a laser light source that emits a laser beam, a diffusion member that condenses the laser beam and then diffuses the laser beam, and a projection member that projects the laser beam diffused by the diffusion member, and the relative position between the diffusion member and the projection member is adjusted such that the divergence angle of the light projected from the projector is minimized.

Furthermore, an illumination device according to the present application is a projector that includes a laser light source that emits a laser beam, a diffusion member that condenses the laser beam and then diffuses the laser beam, and a projection member that projects the laser beam diffused by the diffusion member, and the projection member images the light distribution of the laser beam diffused by the diffusion member on the diffusion member onto a location at a desired distance.

Furthermore, an illumination device according to the present application may be configured to be capable of changing the relative position between the projection member and the diffusion member.

Furthermore, in an illumination device according to the present application, the wavelength of the laser light source may be any wavelength in the wavelength band of from 740 nm to 1000 nm.

Furthermore, in an illumination device according to the present application, the diffusion member may be a member that has concavities and convexities in the surface thereof and that is made of metal. In this case, the illumination device according to the present application may be configured to make a laser beam incident on a predetermined surface of the diffusion member and to project, by the projection member, diffused light radiated from the side that is identical to the side on which the laser beam is incident.

Furthermore, in an illumination device according to the present application, the diffusion member may be a transparent member that diffuses a laser beam while transmitting the laser beam. In this case, the illumination device according to the present application may be configured to make a laser beam incident on a predetermined surface of the diffusion member and to project, by the projection member, diffused light radiated from the side opposite to the side on which the laser beam is incident.

Furthermore, in an illumination device according to the present application, the diffusion member may be a waveguide member that guides a laser beam. In this case, the illumination device according to the present application may be configured to make a laser beam incident on one end of the diffusion member and to project the laser beam radiated from another end by the projection member. The diffusion member may be a multimode fiber. Alternatively, the diffusion member may be a rod lens. Alternatively, the diffusion member may be a tapering waveguide.

Furthermore, in an illumination device according to the present application, the laser light source may be provided in a plurality, and the plurality of laser beams emitted by the respective laser light sources may impinge on one location on the diffusion member. In this case, the laser beams emitted by the respective laser light sources may include laser beams having mutually different wavelengths.

Furthermore, in an illumination device according to the present application, the projection member may be a lens. In addition, in an illumination device according to the present application, the projection member may be a concave mirror.

Furthermore, an observation system according to the present application may include the illumination device described above (projector), and a camera device for observing a projected image of light projected from the illumination device.

The present invention is not limited to the embodiments described above, and various modifications can be made within the scope set forth in the claims. An embodiment obtained by combining as appropriate technical means disclosed in different embodiments is also encompassed by the technical scope of the present invention. Furthermore, a new technical feature can be formed by combining technical means disclosed in the embodiments.

### INDUSTRIAL APPLICABILITY

The present invention can be used in an illumination device that projects a near-infrared laser beam.

### REFERENCE SIGNS LIST

1 INFRARED SEMICONDUCTOR LASER ELEMENT (LASER LIGHT SOURCE)
5 DIFFUSION MEMBER
6 PROJECTION LENS (PROJECTION MEMBER, LENS)
17 PARABOLOIDAL REFLECTOR (PROJECTION MEMBER, REFLECTOR)
41 PARABOLOIDAL REFLECTOR (PROJECTION MEMBER, REFLECTOR)
51 DIFFUSION MEMBER
52 ROD LENS (DIFFUSION MEMBER)
53 OPTICAL FIBER (DIFFUSION MEMBER)
54 DIFFUSION MEMBER
55 TAPERING WAVEGUIDE MEMBER (DIFFUSION MEMBER)
91 INFRARED CAMERA (IMAGING DEVICE)
200 OBSERVATION SYSTEM
5a LIGHT RECEIVING SURFACE
L1 NEAR-INFRARED LASER BEAM
L2 DIFFUSED LIGHT (DIFFUSED NEAR-INFRARED LASER BEAM, DIFFUSE NEAR-INFRARED LASER BEAM)
IA ILLUMINATION REGION
51a to 55a LIGHT RECEIVING SURFACE
51b to 53b, 55b RADIATION SURFACE
100 to 105 ILLUMINATION DEVICE

1-19. (canceled)

20: An illumination device, comprising:
a laser light source that emits a near-infrared laser beam;
a diffusion member that does not include a fluorescent substance as a primary component and that diffuses the near-infrared laser beam; and
a projection member that projects the near-infrared laser beam diffused by the diffusion member,
wherein the diffusion member includes a light receiving surface that receives the near-infrared laser beam,
wherein the light receiving surface is a rough surface, and
wherein the diffusion member diffuses the near-infrared laser beam at the light receiving surface and radiates the near-infrared laser beam toward the projection member.

21: The illumination device according to claim 20,
wherein the near-infrared laser beam has a peak wavelength in a wavelength band of no shorter than 740 nm nor longer than 1000 nm.

22: The illumination device according to claim 20,
wherein the laser light source is provided in a plurality, and
wherein laser beams emitted by the respective laser light sources have mutually different peak wavelengths.

23: An illumination device, comprising:
a laser light source that emits a near-infrared laser beam;
a diffusion member that does not include a fluorescent substance as a primary component and that diffuses the near-infrared laser beam; and
a projection member that projects the near-infrared laser beam diffused by the diffusion member,
wherein the diffusion member includes a light receiving surface that receives the near-infrared laser beam,
wherein the light receiving surface is a rough surface, and
wherein at least the light receiving surface of the diffusion member is made of metal.

24: The illumination device according to claim 20,
wherein the laser light source is provided in a plurality, and
wherein the plurality of laser light sources emit the respective near-infrared laser beams toward the light receiving surface such that irradiation regions formed by the respective near-infrared laser beams on the light receiving surface overlap each other.

25: The illumination device according to claim 20,
wherein the projection member is a lens that transmits the near-infrared laser beam diffused by the diffusion member.

26: An illumination device, comprising:
a laser light source that emits a near-infrared laser beam;
a diffusion member that does not include a fluorescent substance as a primary component and that diffuses the near-infrared laser beam; and
a projection member that projects the near-infrared laser beam diffused by the diffusion member,
wherein the projection member is a reflector that reflects the near-infrared laser beam diffused by the diffusion member.

27: The illumination device according to claim 20, further comprising:
a changing mechanism that changes a relative position between the diffusion member and the projection member.

28: An observation system, comprising:
the illumination device according to claim 20; and
an imaging device that captures a projected image formed as a target is irradiated with the near-infrared laser beam diffused by the diffusion member and projected by the illumination device.
